(19) United States
(12) Patent Application Publication
(10) Pub. No.: US 2004/0185728 A1
(43) Pub. Date: Sep. 23, 2004

(54) Textiles with high water release rates and methods for making same

(75) Inventors: John W. Moore, Wilmington, DE (US); Christopher S. Moore, Wilmington, DE (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Optimer, Inc.

(21) Appl. No.: 10/394,075

(22) Filed: Mar. 21, 2003

(51) Int. Cl. B32B 27/12; B32B 27/30

(52) U.S. Cl. 442/79; 156/279; 442/93; 442/108; 442/173; 442/174

(57) ABSTRACT

Textiles treated with hydrophobic dispersions that exhibit superior drying rates and lower spin-dry water contents are disclosed. Polytetrafluoroethylene, polyvinyl acetate, and polyvinyl acetate/acrylic copolymer dispersions are used to treat textiles, including yarns, fabrics, linens, and articles of clothing. The use of dispersions create textiles with a discontinuous treatment of discrete individual hydrophobic particles applied to the surface. The treated textiles exhibit superior drying properties at very low levels of treatment. Also provided are methods for treating textiles with hydrophobic dispersions. The incremental cost to the textile of the treatment is minimized by low levels of treatment and flexibility in application.

### FIELD OF THE INVENTION

The present invention relates to textiles that are treated to enhance performance. More particularly, the present invention relates to textiles that are treated to increase water release rates and reduce drying times. Even more particularly, the present invention relates to yarns, fabrics, and articles of clothing that are treated with low levels of dispersions which are more hydrophobic than the textile to which they are applied to reduce drying times, reduce spin-dry water contents, increase water release rates, and improve comfort while offering flexibility and minimal added costs to the manufacturing process.

### BACKGROUND OF THE INVENTION

During both normal everyday activities and athletic activities, a person desires clothing that is comfortable to wear. A key factor in providing comfort is a garment's ability to absorb and release perspiration away from the wearer nearly as fast as it is generated by the wearer. Accordingly, increasing the water release rate of a fabric used in the garment will improve the comfort of the garment. The improved water release rate reduces the drying time after washing or after periods of heavy perspiration.

The drying time of a yarn, fabric, or article of clothing is determined by measuring the amount of time it takes for a yarn, fabric, or article of clothing of a known liquid content to reach its dry weight in known environmental conditions. A more useful measurement for evaluating the ability of a yarn, fabric, or article of clothing to keep the wearer feeling dry is to measure the water release rate of the yarn, fabric, or article of clothing. The water release rate is determined by measuring the change in liquid content of a yarn, fabric, or article of clothing over a fixed time interval. The water release rate of a given yarn, fabric, or article of clothing will depend on the liquid content of the yarn, fabric, or article of clothing as well as environmental conditions. The water release rate at or near dryness is representative of a fabric's ability to keep a person dry during normal use conditions. Accordingly, a comparison of water release rates at or near dryness of various fabrics is useful in determining which fabric will provide more comfort to the wearer.

Attempts have been made to reduce the drying time of a fabric without reducing the fabric's overall comfort. For example, Dupont's CoolMax® performance fabrics are said to dry faster than other fabrics containing natural or synthetic fibers. The CoolMax® fabric, however, requires the use of a synthetic lobed and/or channeled fiber. Accordingly, the fiber must be introduced into the manufacturing process of the yarn to produce CoolMax® fabrics and garments.

The properties of fabrics and garments also can be altered by treatment of the fiber, yarn, fabric, or garment with an agent providing the desired property. For example, flame retardant, antimicrobial, stain resist, or wetting agents can be added to a fiber, yarn, fabric, or garment. The agent can be added after the garment is manufactured by, for example, adding the agent in a bath form or spraying the agent onto the garment.

U.S. Pat. No. 5,590,420 discloses an article of clothing treated with low friction materials, such as DuPont's Teflon®, to reduce the level of friction exhibited by the article of clothing. Most preferably, the level of treatment is incorporated in amounts between 30 and 50% by weight of the treated area, such that the coefficient of friction of the treated material is less than 50% of the coefficient of friction of the untreated material. U.S. Pat. No. 5,590,420 reports that the addition of low friction material to the fiber, yarn, fabric, or garment can be useful to wick away moisture from the skin. The wicking away of moisture is purported to help guard against irritation, as well as wetness. The wicking away of moisture, however, does not necessarily equate to reduced drying times or improved water release rates. For example, a garment that wicks quickly may, nonetheless, have a relatively slow drying time and low water release rate. The wicking rate of a fabric is dependent upon capillary forces and is usually considered when a fluid moves along a surface, not away from the surface. The drying time or water release rate depends on the differential forces that attract and repel fluid to or from the surface. Accordingly, U.S. Pat. No. 5,590,420 does not disclose, teach, or suggest a cost-effective method for improving the water release rates of fibers, yarns, fabrics, or garments

U.S. Pat. No. 5,575,012 discloses a method for treating socks to reduce friction by applying a fluoropolymer. According to U.S. Pat. No. 5,575,012, the socks provide improved comfort to the wearer as a result of the increased sensation of lubricity, not reduced drying times or improved water release rates.

Therefore, a need exists for a garment that will provide increased comfort to the wearer by reducing drying times or increasing water release rates. In addition to improving comfort, there is a need for a fabric that retains less water after completing the spin-dry cycle in a washing machine. The reduced water content reduces the amount of energy required to dry the fabric. More specifically, there is a need for a fabric that has a faster drying time, lower spin-dry water content, and higher water release rate than conventional fabric. The fabric should be comfortable to wear and offer flexibility and minimize additional costs to the manufacturing process. Preferably, the water release rate of the fabric can be enhanced at any point in the manufacturing process, including before the creation of yarns to after the completion of an article of clothing.

### SUMMARY OF THE INVENTION

The present invention provides a textile material having a surface and a discontinuous treatment located on the surface. The discontinuous treatment includes discrete, individual particles that are more hydrophobic than the surface. The discontinuous treatment is in the range of about 0.1% to about 8% by weight of the textile material and increases the water release rate near dryness of said textile material.

Also provided are fabrics having a hydrophilic surface and a discontinuous treatment that is more hydrophobic than the hydrophilic surface. The discontinuous treatment includes discrete, individual particles located on the hydrophilic surface. The discontinuous treatment is in the range of about 0.1% to about 8% by weight of the fabric and increases the water release rate near dryness of the fabric.

The present invention also provides textile materials having a surface with a discontinuous treatment located on the surface, wherein the discontinuous treatment includes discrete, individual particles of one or more of polyvinyl acetate and a polyvinyl acetate/acrylic copolymer. The discontinuous treatment is present in an amount sufficient to increase the water release rate near dryness of the textile materials.

In certain embodiments, one or more of polytetrafluoroethylene (PTFE), polyvinyl acetate (PVA), and polyvinyl acetate/acrylic copolymer (PVA/a) dispersions are used to treat the textile. Textiles treated with the hydrophobic dispersions exhibit superior drying rates and lower spin-dry water contents. Most surprising, the treated textiles exhibit superior drying properties at very low levels of treatment. By keeping the treatment levels low, the costs of treating the textiles and any negative effects are kept to a minimum.

Also provided are methods for making textiles of the invention. In one aspect, the method includes the step of applying discrete, individual particles of a treatment on a textile surface, wherein the treatment is more hydrophobic than the textile material, the treatment is in the range of about 0.1% to about 8% by weight of the textile material, and the treatment increases the initial water release rate of said textile material.

In other embodiments, the treatment is applied to a fabric or an article of clothing. The variety of methods available for applying the dispersion offers flexibility to the manufacturing process.

The present invention thus introduces textiles and methods for producing textiles that have superior performance characteristics and are cost effective to manufacture. In certain embodiments, the textile is an article of clothing, where the improved water release rate of the treated fabric near dryness helps keep the wearer dry, whether the wearer is vigorously exercising or inactive. In other embodiments, the textile is a linen, where the reduced spin-dry water content of the treated fabric helps reduce drying time and associated energy costs. In another embodiment, the textile is a yarn that can be used to create fabrics having superior performance characteristics.

Other features of the invention are described below.

### BRIEF DESCRIPTION OF THE DRAWINGS

The foregoing and other features and advantages of the present invention will be more clearly understood from the following figures which represent non-limiting examples of the invention and wherein the different figures represent:

FIG. 1 is a graphical plot comparing the drying rates of treated and untreated t-shirts made from 100% polyester;

FIG. 2 is a graphical plot comparing the drying rates of treated and untreated t-shirts made from CoolMax® 100% polyester;

FIG. 3 is a graphical plot comparing the drying rates of treated and untreated t-shirts made from a 88% co-polyester with 12% wool blend;

FIG. 4 is a graphical plot comparing the drying rates of treated and untreated t-shirts made from yarns of an intimate blend of 85% Comfortrel® co-polyester with 15% cotton;

FIG. 5 is a graphical plot comparing the drying rates of treated and untreated Dri-release® t-shirts made from 85% Comfortrel® co-polyester and 15% cotton blend and a t-shirt made from a 100% Comfortrel® co-polyester with an Akwatek® treatment;

FIG. 6 is a graphical plot comparing the drying rates of treated and untreated t-shirts made from 100% cotton;

FIG. 7 is a graphical plot comparing the spin-dry water content and friction properties of socks having various levels of PTFE treatment;

FIG. 8 is a graphical plot comparing the spin-dry water contents and drying rates of 100% cotton samples with various levels of PTFE treatment applied;

FIG. 9 is a graphical plot comparing the spin-dry water contents and drying rates of Dri-Release® samples with various types of treatment applied;

FIG. 10 is a graphical plot comparing water release rates of PTFE and PVA/a treated flat knit socks;

FIG. 11 is a graphical plot comparing water release rates of PTFE and PVA/a treated flat knit socks relative to water release rates of an untreated control;

FIG. 12 is a graphical plot comparing low water content water release rates of PTFE and PVA/a treated flat knit socks;

FIG. 13 is a graphical plot comparing water release rates of PTFE and PVA/a treated terry socks;

FIG. 14 is a graphical plot comparing water release rates of PTFE and PVA/a treated flat knit socks at water content levels below 1%;

FIG. 15 is a graphical plot comparing water release rates of PTFE and PVA/a treated terry socks at water content levels below 2%;

FIG. 16 is a graphical plot comparing water release rates of PTFE and PVA/a treated flat knit socks at water content levels below 2% after two soak and spin-dry cycles;

FIG. 17 is a graphical plot comparing water release rates of PTFE and PVA/a treated terry socks at water content levels below 2% after two soak and spin-dry cycles;

FIG. 18 is a graphical plot comparing drying times of PTFE and PVA/a treated flat knit socks after three soak and spin-dry cycles;

FIG. 19 is a graphical plot comparing drying times of PTFE and PVA/a treated terry socks after three soak and spin-dry cycles;

FIG. 20 is a graphical plot comparing the water content upon removal from a five minute spin-dry cycle for each of three spin-dry cycles for flat knit socks treated with PTFE and PVA/a;

FIG. 21 is a graphical plot comparing the water content upon removal from a five minute spin-dry cycle for each of three spin-dry cycles for terry knit socks treated with PTFE and PVA/a;

FIG. 22 is a graphical plot comparing the friction properties of fabrics treated with various levels of PVA, PVA/a, and PTFE;

FIG. 23 is a graphical plot comparing the drying time test results of a 5.0 oz/yd² Dri-release® fabric left untreated, treated with 0.17% PVA, and treated with 0.17% PVA/a particles;

FIG. 24 is a graphical plot comparing water release rates of an unwashed CoolMax® Alta fabric left untreated, treated with 0.17% PVA, and treated with 0.17% PVA/a particles;

FIG. 25 is a graphical plot comparing water release rates of a CoolMax® Alta fabric left untreated, treated with 0.17% PVA, and treated with 0.17% PVA/a particles after one washing;

FIG. 26 is a graphical plot comparing water release rates of a CoolMax® Alta fabric left untreated, treated with 0.17% PVA, and treated with 0.17% PVA/a particles after repeated washing and further treatment with 0.17% PTFE;

FIG. 27 is a graphical plot comparing water release rates of an unwashed 4.0 oz/yd² Dri-release® fabric left untreated and treated with 0.17% PTFE;

FIG. 28 is a graphical plot comparing blotting wetness of yarns treated with various levels of PTFE;

FIG. 29 is a graphical plot comparing water release rates near the spin-dry water content and overall water release rates of yarns treated with various levels of PTFE;

FIG. 30 is a graphical plot comparing frictional properties of yarns treated with various levels of PTFE;

FIG. 31 is a graphical plot comparing basis weights of fabrics knitted from yarns treated with various levels of PTFE; and

FIG. 32 is a graphical plot comparing drying rates of mercerized cotton samples treated with PVA, PVA/a, and PTFE;

FIG. 33 is a chart comparing the drying rates at various water content levels of mercerized cotton samples treated with PVA, PVA/a, and PTFE relative to the drying rate of a control sample;

FIG. 34 is a graphical plot comparing drying rates of mercerized cotton samples treated with PVA, PVA/a, and PTFE;

FIG. 35 is a chart comparing the drying rates at various water content levels of mercerized cotton samples treated with PVA, PVA/a, and PTFE relative to the drying rate of a control sample;

FIG. 36 is a chart comparing the water release rates of an 85/15 polyester/cotton t-shirt fabric treated with various levels of PTFE;

FIG. 37 is a chart comparing the water release rates of treated and untreated Levi Type 505® 14.4 oz/yd² denim;

FIG. 38 is a chart comparing the water release rates of a treated and untreated 12.6 oz/yd² 75/25 polyester/cotton denim fabric;

FIG. 39 is a chart comparing the water release rates of treated and untreated Levi Type 505® 14.4 oz/yd² denim at an elevated temperature;

FIG. 40 is a chart comparing the water release rates of a treated and untreated 12.6 oz/yd² 75/25 polyester/cotton denim fabric at an elevated temperature; and

FIG. 41 is a chart comparing the water release rates of Levi Type 505® 14.4 oz/yd² denim without treatment, with treatment applied to the face, and with treatment applied to the back.

### DETAILED DESCRIPTION

The present invention provides textiles treated with the hydrophobic dispersions. The treated textiles exhibit superior drying rates and lower spin-dry water contents when compared to comparable untreated textiles. Most surprising, the treated textiles exhibit superior drying properties at very low levels of treatment. The increased drying rates improve the overall comfort of articles of clothing, whether the wearer is vigorously exercising or inactive. In certain embodiments, the drying rate of the treated fabric exceeds the average perspiration rate of a person actively exercising.

In the context of this invention, the term “textile” shall mean a fiber, filament, yarn, fabric, or any article made from fabric, including, for example, articles of clothing, bedding, linens, and drapery. The term “articles of clothing” include any article of clothing including, for example, underwear, t-shirts, shirts, pants, socks, hats, diapers, and jackets. The term “linen” as used herein, refers to any article routinely washed in a residential or commercial washing machine besides articles of clothing, including, for example, sheets, blankets, towels, drapery, wash cloths, napkins, table cloths, and pillow cases.

The textiles of the present invention can be made from natural or synthetic fibers, including, for example, cotton, rayon, polynosic, lyocell, polyester, wool, nylon, silk, acrylic, elasthane, spandex, polyolefins, or combinations thereof.

In certain embodiments, the surface energy of the textile ranges from about 18 to about 50 dynes/cm². The textiles of the present invention may be hydrophilic or hydrophobic textiles. The term “hydrophilic textile” for purposes of this invention means textiles that will absorb at least about 4.5 percent of their weight in water. Examples of hydrophilic textiles include cellulosic textiles such as cotton and rayon, as well as wool and polyvinylalcohol.

The “liquid content” of yarn, fabric, or article of clothing is determined by dividing the difference between the wet weight and dry weight by the dry weight. For example, a 10 ounce per square yard fabric that when wet weighs 15 ounces per square yard, has a 50% liquid content. The term “water content” is used interchangeably with the term liquid content when the liquid is water or mostly water. Water is generally used as an approximation of perspiration, which is mostly water with some additional amounts of oils, proteins, and salts.

The drying time of a yarn, fabric, or article of clothing is determined by measuring the amount of time it takes for a yarn, fabric, or article of clothing of a known liquid content to reach its dry weight in known environmental conditions. The rate of change in water content, or “water release rate” is determined by measuring the change in liquid content of a yarn, fabric, or article of clothing over a fixed time interval. The water release rate of a given yarn, fabric, or article of clothing will depend on the liquid content of the yarn, fabric, or article of clothing as well as environmental conditions. The water release rate is the average slope of the drying curve over a given water content range or time interval and does not depend significantly on whether the fabric is getting dryer or wetter. Preferably, water release rates are measured in a controlled environment, typically about 70° F. and 30% R.H. The term “water release rate near dryness” is the water release rate at water content levels below about 10%, the approximate level at which a garment begins to feel wet to the wearer.

Polytetrafluoroethylene (PTFE) fibers, yarns, and fabrics absorb and wick very little water. On the other hand, cotton fibers, yarns, and fabrics absorb and wick much higher levels of water due to the cotton's chemical structure of many hydroxyl groups that tend to attract water. Thus, it is surprising that small amounts of a PTFE dispersion applied to cotton yarns, fabrics, or articles of clothing causes a large increase in the water release rates of the treated articles. Likewise, it is surprising that dispersions of hydrophobic polyvinyl acetate (PVA) or polyvinyl acetate/acrylic copolymer (PVA/a) cause similar large increases in the water release rate of treated articles. The PVA and PVA/a dispersions are of particular interest because of their economic advantages.

The PTFE, PVA, and PVA/a dispersions of the present invention are applied in amounts ranging from about 0.1% to about 8% by weight of the textile material. In certain embodiments, the PTFE, PVA, and PVA/a dispersions are applied in amounts ranging from about 0.1% to about 4% by weight of the textile material. In further embodiments, the PTFE, PVA, and PVA/a dispersions are applied in amounts ranging from about 0.1% to about 2% by weight of the textile material. Other embodiments have PTFE, PVA, and PVA/a dispersions applied in amounts ranging from about 0.1% to about 1% by weight of the textile material

The PTFE, PVA, and PVA/a dispersions usually are an aqueous dispersion that can include additives such as wetting agents, pigments, and stabilizers. The quantity of PTFE, PVA, and PVA/a particles in the dispersion can range from about 0.1% to about 60% by weight of the dispersion.

The surface energy of the dispersion particles can vary from one embodiment to another, however, the surface energy of the dispersion particles for any particular embodiment is greater than the surface energy of the textile being treated, whether the textile is hydrophilic or hydrophobic (i.e. the particles are more hydrophobic than the surface to which they are being applied). In certain embodiments, the surface energy of the dispersion particles ranges from about 28 to about 75 dynes/cm².

The discrete, individual particles useful in the textile materials, fabrics and methods of the invention are more hydrophobic in nature than the surface to which they are to be applied to improve its water release characteristics. Preferably, the particles contain at least one polymeric material. However, the particles may include inorganic and organic non-polymeric additives, provided that their inclusion does not render the final particles less hydrophobic than the surface to which they are to be applied. Suitable inorganic additives include, for example, pigments, such as calcium carbonate or titanium dioxide, and colorants.

The polymeric particles may be solid or contain voids. The polymers may be single staged or multi-staged, such as for example, a core/shell polymer. The polymers useful in the invention may be linear or branched and, if copolymers, may be random or block copolymers. The polymeric particles may be blends of one or more different polymers. The polymers may formed by any conventional polymerization techniques, including condensation and free-radical polymerization techniques, such as emulsion and suspension polymerization. Conventional free-radical polymerization techniques are described, for example in Lovell and El Asser, Emulsion Polymerization and Emulsion Polymers, John Wiley and Sons, 1997, U.S. Pat. No. 4,335,238 and Canadian Patent No. 2,147,045. Preferably, the particles are formed in an aqueous free radical polymerization to form an aqueous dispersion of latex polymer particles.

The polymeric particles useful in the invention may have a particles size of about 100 nm to about 1 μm. The particle size and void fraction of the polymeric particles may be determined by conventional techniques known, including microscopy and the Brookhaven Model BI-90 Particle Sizer supplied by Brookhaven Instruments Corporation, Holtsville, N.Y., which employs a quasi-elastic light scattering technique to measure the size of the particles.

The molecular weights of the polymers useful in the invention are typically from about 100,000 to 5 million weight average and most commonly above 500,000.

Preferably, the polymeric particles useful in the invention have a glass transition temperature, as measured by differential scanning calorimetry at a rate of 20° C. per minute of at least 20° C. and, more preferably, of at least 50° C. A higher glass transition temperature contributes to a harder particle that is less likely to deform when applied to the surface and under the conditions of use, such as repeated washing and drying at elevated temperatures.

The preferred polymers include:

fluoro-containing homopolymers and copolymers;

homopolymers and copolymers of vinyl esters of an aliphatic acid having 1 to 18 carbon atoms; and

copolymers of vinyl esters of an aliphatic acid having 1 to 18 carbon atoms with alkyl (meth)acrylate monomers.

Suitable fluoro-containing homopolymers and copolymers include fluoropolymers such as PTFE TEFLON®, FEP TEFLON®, Tefzel®, poly(vinylidene fluoride), PVDF, and perfluoroalkoxy resins. Suitable fluorine-containing ethylenically unsaturated monomers for use in the preparation of the fluoro-containing homopolymers and copolymers include the terminally unsaturated monoolefins typically used for the preparation of fluorine-containing elastomers, such as hexafluoropropene, chlorotrifluoroethylene, 2-chloropentafluoropropene, perfluoroalkyl vinyl ethers, e.g., CF₃OCF═CF₂ or CF₃CF₂OCF═CF₂, tetrafluoroethylene, dichlorodifluoroethylene, 1,1-dichlorofluoroethylene, vinylidene fluoride, vinyl fluoride, and mixtures thereof. Polytetrafluoroethylene is preferred. Fluorine-free terminally unsaturated monoolefin comonomers, e.g., ethylene or propylene, may also be used as comonomers.

Suitable homopolymers and copolymers of vinyl esters of an aliphatic acid having 1 to 18 carbon atoms include poly(vinyl acetate) and copolymers of vinyl acetate copolymerized with one or more of the following monomers: vinyl chloride, vinylidene chloride, styrene, vinyltoluene, acrylonitrile and methacrylonitrile. Poly(vinyl acetate) is preferred.

Suitable alkyl(meth)acrylate monomers include, for example, the C₁₋₁₈ alkyl(meth)acrylate monomers (e.g., methyl-, ethyl-, propyl-, n-butyl-, sec-butyl-, tert-butyl, pentyl-, hexyl-, heptyl-, n-octyl-, 2-ethylhexyl-, decyl-, undecyl-, dodecyl-, lauryl, cetyl, and stearyl-(meth)acrylate and the like. The term “alkyl(meth)acrylate,” as used herein, refers to both alkyl acrylate and alkyl methacrylate monomer compounds. Copolymers of vinyl acetate polymerized with an acrylate monomer are preferred.

The above-described polymers, particularly the homopolymers of vinyl esters and copolymers of vinyl esters with acrylates, may also be formed from minor amounts, that is no more than about 25% by weight, based on the total weight of the polymer particle, of other mono- and poly-ethylenically unsaturated monomers commonly known in the art, such as those listed in The Polymer Handbook, 3rd Edition, Brandrup and Immergut, Eds., Wiley Interscience, Chapter 2, 1989 and WO 93/12184. These optional monomers include vinyl-unsaturated carboxylic acids monomers (e.g., methacrylic acid, acrylic acid, maleic acid, itaconic acid); C₁₋₁₈ alkyl (meth)acrylamides; dienes (e.g., butadiene and isoprene); polyunsaturated (e.g., divinylbenzene, divinylpyridine, divinyltoluene, diallyl phthalate, ethylene glycol diacrylate, ethylene glycol dimethacrylate, divinylxylene, divinylethylbenzene, divinylsulfone, divinylketone, divinylsulfide, allyl methacrylate, diallyl maleate, diallyl fumarate, diallyl succinate, diallyl carbonate, diallyl malonate, diallyl oxalate, diallyl adipate, diallyl sebacate, divinyl sebacate, diallyl tartrate, diallyl silicate, triallyl tricarballylate, triallyl aconitate, triallyl citrate, triallyl phosphate, N,N-methylene dimethacrylamide, N,N-methylene dimethacrylamide, N,N-ethylenediacrylamide, trivinylbenzene, and the polyvinyl ethers of glycol, glycerol, pentaerythritol, resorcinol, monothio and dithio derivatives of glycols, butylene glycol dimethacrylate, alkanepolyol-polyacrylates or alkane polyol-polymethacrylates and unsaturated carboxylic acid allyl esters such as allyl acrylate, diallyl maleate, and typically allyl methacrylate) and the like.

In certain embodiments of this invention, a small amount, such as from 0.5 to 5.0 weight % or more, preferably about 1.0 weight %, of an acid monomer is included in the monomer mixture used for making the copolymers. Suitable acid monomers include acrylic, methacrylic, itaconic, aconitic, citraconic, crotonic, maleic, fumaric, the dimer of acrylic acid, and the like.

A common theory among performance textile experts has been that changing the hydrophobic surface of synthetic fibers (e.g. polyester) to be more hydrophilic by coating or chemical treatment causes better wicking, and thus better performance. The wicking of moisture within a fabric, however, does not necessarily equate to reduced drying times or improved water release rates. For example, a garment that wicks quickly may, nonetheless, have a relatively slow drying time. As shown in the examples below, the hydrophilic-modified CoolMax® Alta and Akwatek® fabrics, which are alleged to have above-average wicking rates, tend to have low water release rates near dryness after washing. The CoolMax® Alta and Akwatek® fabrics both benefit from the surprising improvement in water release rates that the treatment with hydrophobic particles cause, even at treatment levels as low as 0.17% by weight of the fabric.

Another important factor in evaluating yarns, fabrics, and articles of clothing is how easily they release water from a saturated state, as in spin-drying at the end of a machine wash cycle, or in being wrung by hand. This is a factor in the overall drying time of the article as it defines the starting point in water content for the air-drying or heated machine-drying processes. Accordingly, lowering the spin-dry water content of a fabric provides economic savings by reducing the amount of energy required to dry the fabric. Uniform companies, hospitals, hotels, and other service providers that use commercial dryers to dry large volumes of textiles can benefit significantly from reduced drying times and the reduced energy costs. In addition to reduced energy costs, reduced drying times are also beneficial. Travelers, for example, prefer clothes that dry quickly.

The treated fabrics of the present invention can be used for any article of clothing, including shirts, pants, and socks. Socks, for example, can be uncomfortable when perspiration creates a feeling of dampness. This condition can be exacerbated by wearing shoes with limited air circulation. The present invention improves the comfort of the sock by increasing the rate at which the sock will release perspiration to the surrounding environment. In addition to the added comfort resulting from a relatively dry foot, the present invention helps retard the growth of harmful bacteria, fungus, and other related foot conditions.

As further described in the examples below, the textiles of the present invention can be treated in various manners and at varying points in the process. The hydrophobic treatments can be applied using any method known in the art, including, for example, spraying, dipping, soaking, rolling, or brushing. The treatment can be applied at any point in the manufacturing process of fabrics, including the manufacture of fibers and yarns through the completion of the finished fabrics. Alternatively, a finished article of clothing or linen can be treated after it is fabricated.

Applying the treatment to the finished article of clothing or linen provides the opportunity to limit the treatment to certain areas of the article. For example, if treatment is only desired in the portion of a sock normally covered by a shoe, the treatment can be applied to the lower portion of the sock only. Further, applying the treatment after article fabrication allows for varying levels or different types of treatment at different areas within the article. For example, the knit loop portion of a sock can be treated with PTFE and the flat knit portion of a sock can be treated with a higher level of PVA.

In certain embodiments, the treatment is applied earlier in the manufacturing process. For example, the knitted or woven fabrics used to make the clothing and linens can be treated after knitting but prior to sewing. The fabric can be treated on only one side if desired. Further, yarns can be treated prior to knitting or weaving. The treatment of the yarns or fabrics can be done simultaneously with the spinning, weaving, and knitting processes, or can be done independently.

The numerous methods that can be used to apply the dispersion provides flexibility in the manufacturing process and the ability to optimize costs. For example, the overall costs of manufacturing may be lowered by treating the articles after fabrication if the total quantity to be produced is relatively small. Larger quantities may be more effectively produced by treating the yarns or fabrics prior to cutting and sewing.

The type of treatment, level of treatment, placement of treatment, and textile type and condition are all variables that affect the price and performance of the treated textile. As such, various experiments were performed using different parameters to determine the effectiveness of the present invention on various textiles. The present invention will be further clarified by the following examples which are intended to be purely exemplary of the invention.

### EXAMPLES

### Example 1

### Treated T-Shirt Liquid Contents

A 5% by weight water dispersion of PTFE was made by dilution with water from 60% solids Type 30B PTFE (Teflon®) dispersion, available from E.I. Dupont Company. Dri-release® t-shirts made from 85% Wellman Fortrel® co-polyester and 15% cotton fiber blend were then dipped either in the 5% by weight dispersion of PTFE or in water. After dipping the shirts, the shirts were manually wrung to remove as much liquid as possible. The Dri-release® t-shirt dipped in water had a 108.6% water content after hand wringing. The Dri-release® t-shirt dipped in the 5% by weight dispersion of PTFE had a 82% liquid content after hand wringing. Upon overnight drying in air, the Dri-release® t-shirt dipped in water returned to its original dry weight. The Dri-release® t-shirt dipped in the 5% by weight dispersion of PTFE dried to 104.15% of its original weight due to the additional weight of PTFE.

### Example 2

### Treated T-Shirt Drying Times

In addition to the two samples from Example 1, t-shirts made from 100% CoolMax® polyester, an 88% co-polyester with 12% wool blend, an unbranded 1.00% polyester, an Akwatek®-treated hydrophilic Comfortrel® co-polyester, and a 100% cotton were treated similarly to the t-shirts in Example 1. The CoolMax® t-shirt picked up 3.74% PTFE, the 88% co-polyester with 12% wool blend t-shirt picked-up 3.28%, the unbranded 100% polyester t-shirt picked up 4% PTFE, the Akwatek®-treated hydrophilic Comfortrel® co-polyester t-shirt picked up 3.75% PTFE, and the 100% cotton t-shirt picked up 2.77% PTFE. All of the t-shirts were washed and spun dried in a Sears Kenmore 70 Series Heavy Duty Plus residential washing machine before and after treatment using 70 ml of Tide® detergent in a cotton/sturdy, warm/cold, medium load cycle. The t-shirts were weighed immediately after spin-dry to determine the water content of the t-shirts. The t-shirts were kept in a controlled environment of 68° F. and 30% R.H. and weighed at 15 minute intervals. The t-shirts were weighed until dry and water release rates were calculated.

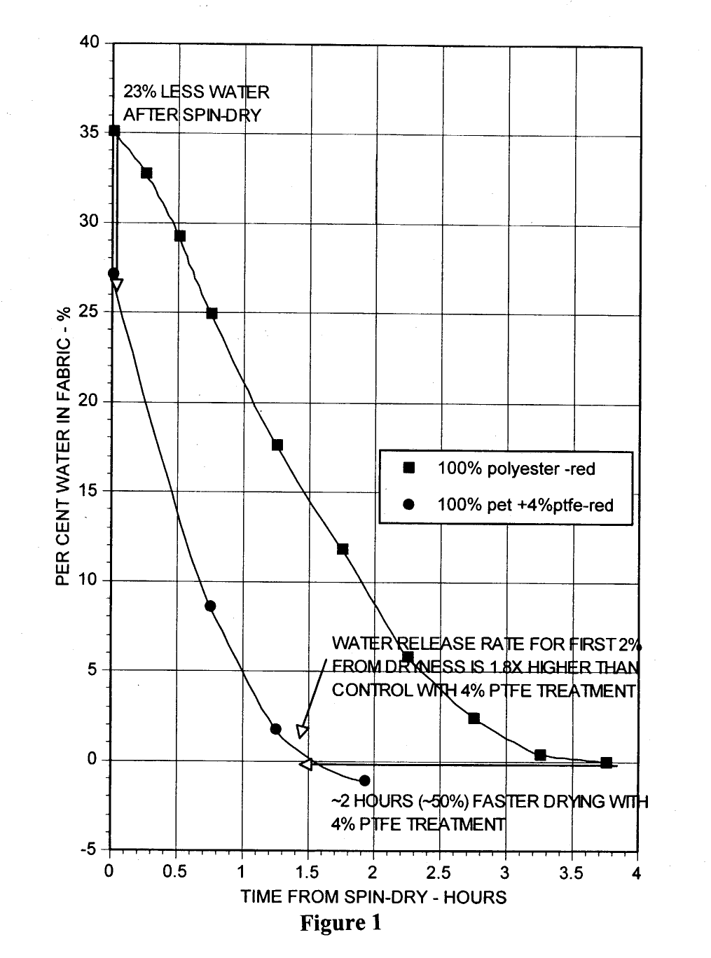

The results are shown in FIGS. 1-5. FIG. 1 compares the drying rates of the treated and untreated unbranded t-shirts made from 100% polyester. As shown in FIG. 1, the 4% PTFE applied to the 100% polyester fiber fabric reduced the water held after spin-dry by 23%, increased the drying rate in the first 45 minutes from spin-dry by 1.54×, increased the water release rate from 0% to 2% water content by 1.8×, and thus together reduced the drying time by 50% or 2 hours versus the untreated control.

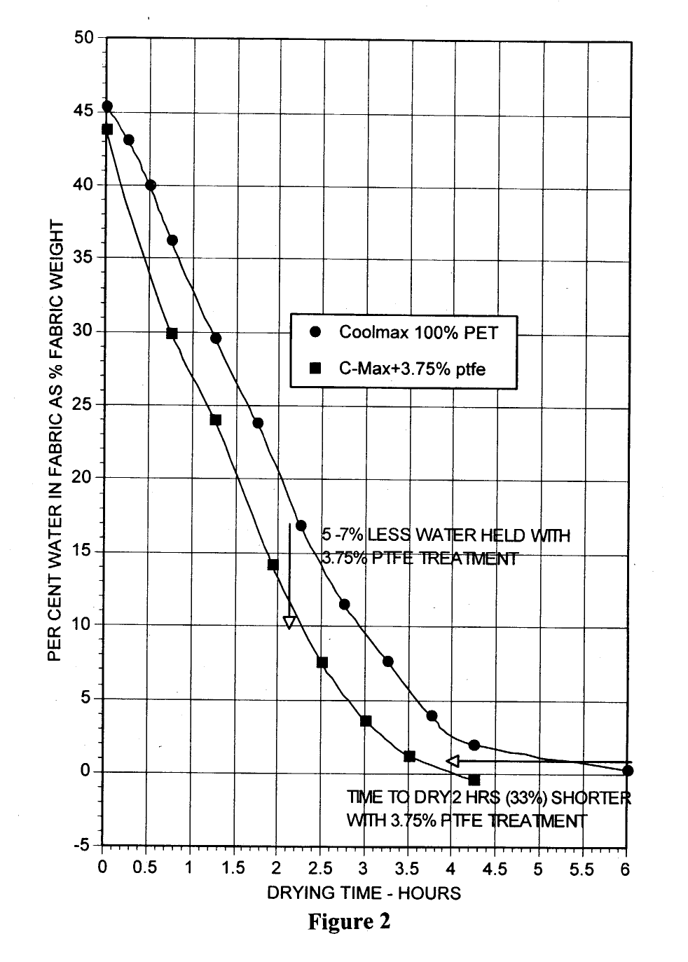

FIG. 2 compares the drying rates of the treated and untreated t-shirts made from CoolMax® 100% polyester. As shown in FIG. 2, the 3.75% PTFE applied to the square, grooved CoolMax® polyester did not reduce the spin-dry water as much (only 3.5%) as the Dri-release® in FIG. 1, but increased the drying rate from spin-dry by a similar 1.5×, and the water release rate near dryness by a greater 2.2× ratio to give an overall 30% or 1.8 hours reduced drying time versus control.

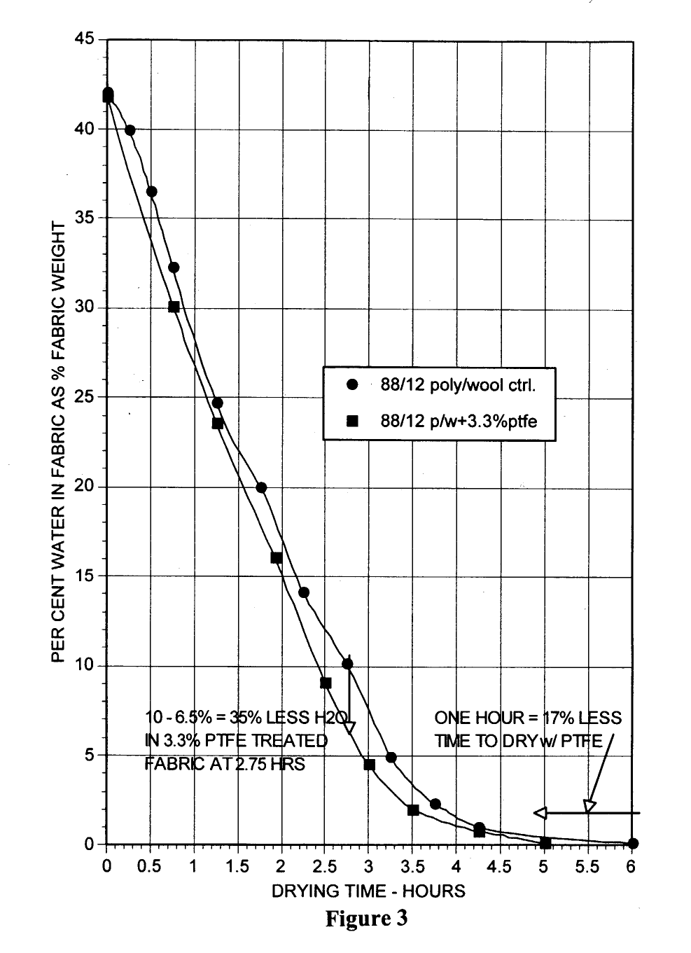

FIG. 3 compares the drying rates of the treated and untreated 88% co-polyester with 12% wool blend t-shirts made from 88% copolyester with 12% wool blend. As shown in FIG. 3, the 3.3% PTFE treatment applied to an 88/12% blend of co-polyester and wool increased the drying rate in the first 45 minutes by 1.21×, but gave essentially the same or lower drying rates over the rest of the range such that the overall drying times of test and control were not different.

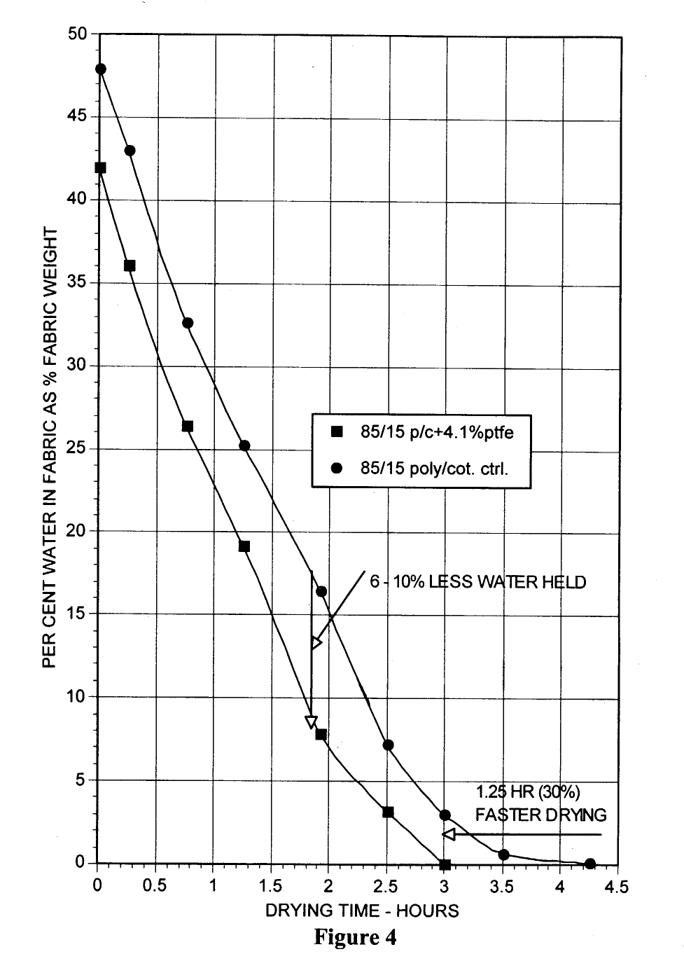

FIG. 4 compares the drying rates of the treated and untreated t-shirts made from an intimate blend of 85% Comfortrel® co-polyester with 15% cotton yarns. As shown in FIG. 4, 4.1% PTFE applied to an intimate blend of 85% Comfortrel® co-polyester with 15% cotton yarns in a t-shirt reduced the spin-dry water held by 12.5%, increased the drying rate in the first 15 minutes by 1.2×, and the water release rate from 0% to 3% water content by 1.34× to give an overall ˜30%, or 1.25 hour reduced drying time versus the same blend fabric without PTFE applied.

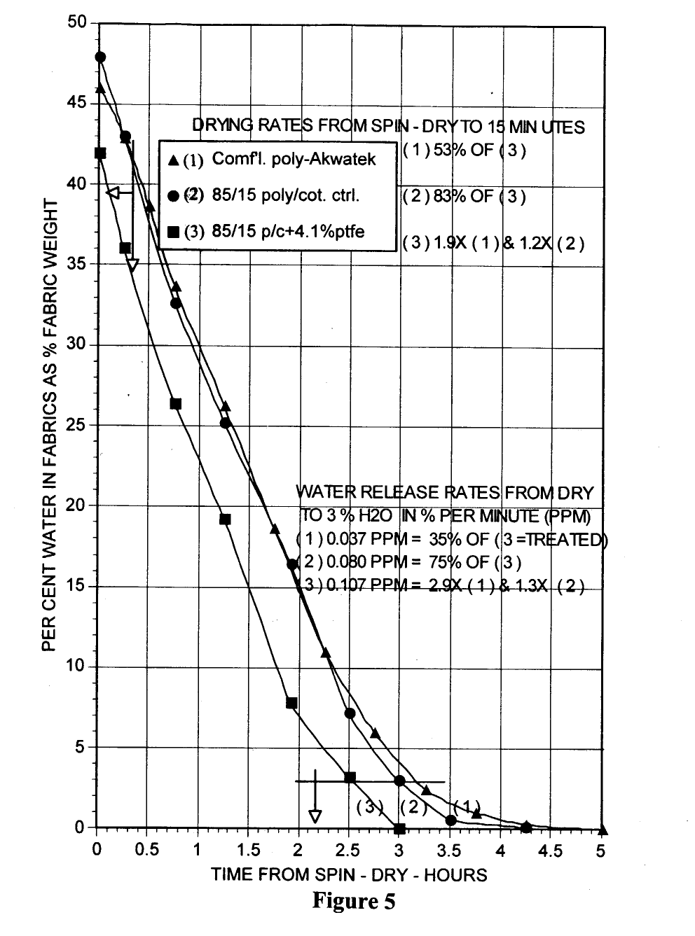

FIG. 5 compares the drying rates of treated and untreated Dri-release® t-shirts made from 85% Comfortrel® co-polyester and 15% cotton blend, and a t-shirt made from a 100% Comfortrel® co-polyester with an Akwatek® treatment. As shown in FIG. 5, the t-shirt made of 100% Comfortrel® co-polyester yarn with the Akwatek® treatment, which renders the entire surface of the fibers more hydrophilic, is compared to the 85% Comfortrel® co-polyester and 15% cotton blend. The spin-dry water is reduced 8.7%, the drying rate from spin-dry is increased by 1.9×, the water release rate near dryness is increased 2.9× resulting in a 50%, or 3 hour, reduction in drying time.

This demonstrates that adding particles of more hydrophobic material to less hydrophobic fibers is superior to making their surfaces more hydrophilic when attempting to improve water release rates and drying times.

As shown in FIGS. 1-5, the 100% and 85% polyester shirts gave the most improvement in drying after treatment. The CoolMax® 100% polyester t-shirt dried in 4 hours with 3.75% PTFE versus more than 6 hours without PTFE. The treated test started with only 2% less water, but had up to 7% less water due to faster drying rate after two hours of air drying at 72° F. and 29% R.H. The result is that the PTFE-treated shirt felt dry an hour before the same shirt without PTFE treatment. This difference increased to 2 hours at full dryness because the untreated CoolMax® drying rate went down to 1% water content loss per minute below 3% water content, while the 3.75% PTFE raised its rate to 2.1% water content loss per minute in this range, or more than double.

The 100% Comfortrel® co-polyester shirt also took up to 3 hours longer to dry to 0% water content and was up to 10% more wet at 2 hours even though it was only slightly more wet after the spin-dry cycle (46 v. 44% water content to start). The initial and final drying rates were both significantly higher with the PTFE treatment than without. The Dri-release® t-shirt took about an hour longer to dry without PTFE treatment and, with 4.1% PTFE treatment added, had a higher drying rate to 0% water.

The 88% co-polyester with 12% wool blend t-shirt had an increased drying rate near dryness with the PTFE treatment, but had less improvement over the non-treated t-shirt near dryness and less than an hour better dry time.

### Example 3

### PTFE Transfer From Treated to Untreated T-Shirts

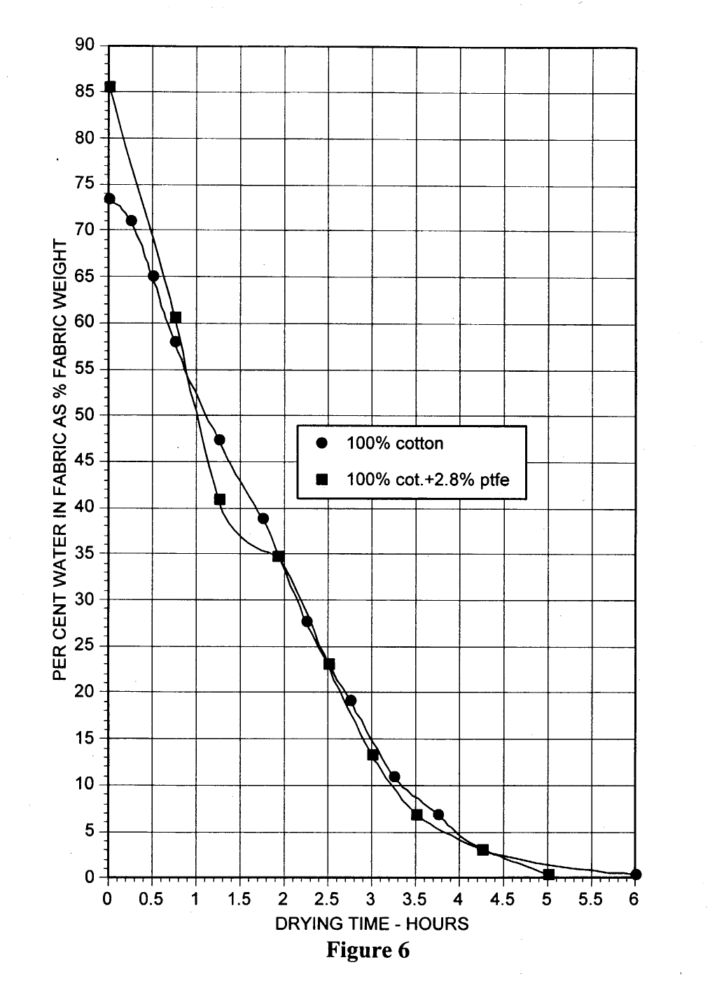

The 100% cotton t-shirts of Example 2 were washed with a red polyester shirt that had been treated previously with PTFE. FIG. 6 compares the drying rates of the treated and untreated t-shirts made from 100% cotton. Some of the red color transferred from the treated shirt to the untreated control. As shown in FIG. 6, the untreated t-shirt started with a water content that was 12% below the water content of the 2.8% PTFE treated t-shirt and both t-shirts dried at about the same rate. The comparable drying rates indicate that some of the PTFE treatment also transferred along with the dye from the treated shirt to the untreated control. The amount of PTFE treatment transferred was not measurable. Surprisingly, the low level of PTFE in the “untreated” control provided comparable results to the 2.8% PTFE treated samples.

### Example 4

### Treated Socks Water Content

Ten PRO-FEET Style 646 Ped socks made by Pro-Feet, Inc. made with 100% polyester yarn were washed and spun dried in a residential washing machine using Tide detergent in a permanent press, warm/cold, medium load cycle. The socks, were dried in a residential dryer.

A 2.5% by weight water dispersion of PTFE was made by dilution with water from 60% solids Type 30B PTFE (Teflon®) dispersion, available from E.I. Dupont Company. The 2.5% by weight water dispersion of PTFE was brushed onto the interior of the socks at various application levels: three socks were not treated, two socks were treated lightly, four socks were treated intermediately, and one sock was treated heavily. After drying, the socks were washed and spun dried in a residential washing machine without detergent in a permanent press, warm/cold, medium load cycle. The socks were removed from the washer about 10 minutes after the spin-dry cycle had stopped. The socks were weighed to determine how much water was retained after the spin-dry.

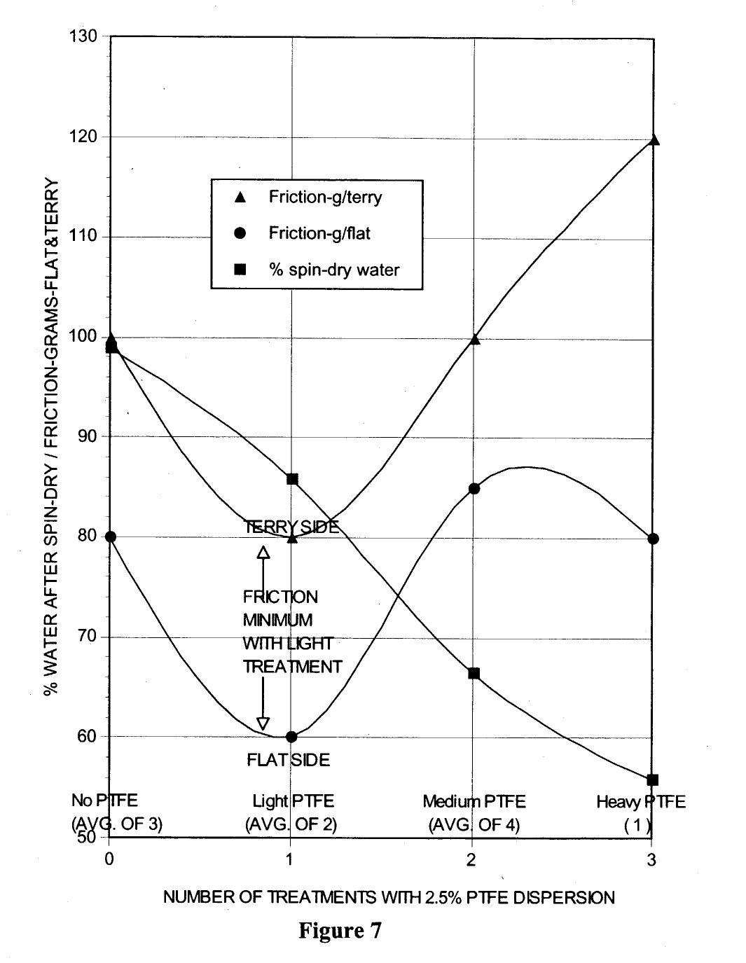

The three untreated socks had an average of 99% water content. The two lightly treated socks averaged 86% water content. The medium treated socks averaged 67% water content. The heavy treated sock had 56% water content. FIG. 7 shows this reduction in water held as the PTFE treatment is increased. As shown in FIG. 7, small amounts of PTFE treatment can create a significant reduction in water content.

### Example 5

### Friction Properties of PTFE Treated Socks

FIG. 7 shows the variation of friction measured in grams force to start a weighted sled moving on the inside terry (loop) pile and outside flat knit surface on each of the socks from Example 4. An elastic band was calibrated in grams force required to elongate the band a given length. This band was then used to increase force on the weighted sled until it would begin to move over the sock surface. The measurements were found to be very repeatable with a variation of +/−10%. The sled required 100 grams force to start moving on the inner terry loop side, but only 80 grams on the smoother outside flat knit, as would be expected.

As shown in FIG. 7, the friction force was reduced 20% for the loop side and 25% for the flat side of the socks with light treatment. The intermediary and heavily treated socks surprisingly took more force than the light treated socks to start the sled moving. The flat knit side appeared to level off at about the same force as the untreated socks, but the friction of the terry loop side continued to increase with the heavy treatment.

### Example 6

### Drying Rates of 100% Cotton at Various Treatment Levels

2.75 inch diameter disks were punched from samples of a 4.4 oz/yd² 100% cotton jersey. The disks were cut using a standard J.A. King & Co., Inc. 3090AC2 sample cutter used for fabric basis weight testing.

A water dispersion of PTFE was made by dilution with water from 60% solids Type 30B PTFE (Teflon®) dispersion, available from E.I. Dupont Company. After weighing the disks, the PTFE dispersion was applied to the disks at various levels and the amount of PTFE treatment added was determined after drying.

The treated disks along with control samples were then soaked in water. The wet disks were then placed on the sidewalls of a Kenmore heavy-duty washer and spun-dry using the Permanent Press spin-dry cycle. The disks were weighed immediately after spin-dry to determine the water content of the disks. The disks were kept in a 72° F./40 R.H. environment and weighed in fixed time intervals. Between weighing, the disks were placed on a non-absorbent surface. The disks were weighed until dry and water release rates were calculated.

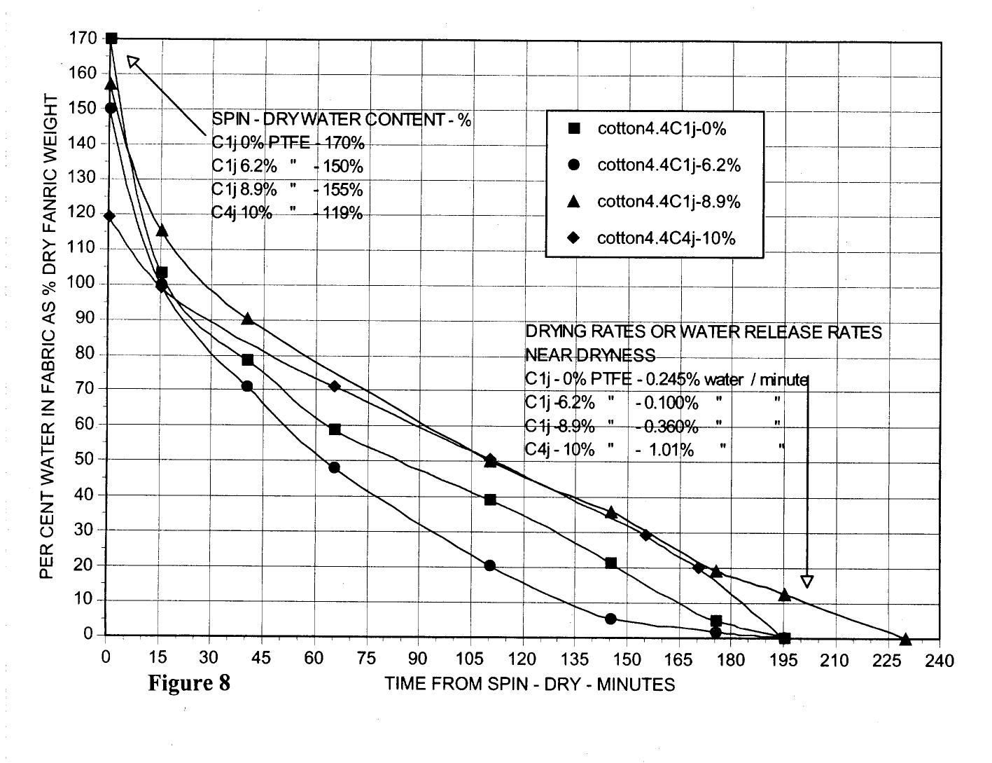

FIG. 8 compares the spin-dry water contents and drying rates of the 100% cotton samples with various levels of PTFE treatment applied. As shown in FIG. 8, the sample with 6.2% PTFE treatment added caused its spin-dry water content to drop 20% from 170% to 150%, or 3× the amount of PTFE treatment added. This effect levels out when 8.9% PTFE treatment is added, but then increases rapidly at the 10% PTFE treatment level to a 51% reduction from the untreated cotton (170% to 119%). The even more surprising effect is on the water release rate near dryness or evaporation rate of water from the dry state where most garments are donned by wearers. At 6.2% PTFE treatment, the water release rate near dryness rate is decreased 2.45× from 0.245 to 0.100% water content per minute. At 8.9% PTFE treatment levels, the water release rate near dryness rate increases 47% to 0.36% water content per minute, and at 10% PTFE treatment levels, the rate increases to 312% of the water release rate near dryness of the untreated cotton. This is 31.2 times the effect predicted by averaging the water release rates of a non-wetting dilution with that of cotton.

### Example 7

### Drying Rates of Various Treatment Types to a Common Fabric

Using the methodology of Example 6, various hydrophilic and hydrophobic treatments were applied to a Dri-release® fabric made from 85% Wellman Fortrel® co-polyester and 15% cotton blend. 4.7 to 4.8 oz/yd² basis weight fabrics were used. The treatments included a Dupont Teflon® fluoropolymer hydrophilic stain release at 7.1% add-on, PTFE particles at a 5.5% add-on, a hydrophilic fabric softener FS-4 available from Optimer, Inc. (Wilmington, Del.) at 15.3% add-on, Stantex LS-101 low friction textile finish at 4% add-on, and Belfasin SG low friction textile softener available from Cognis Corp. (Cincinnati, Ohio) at 6.2% add-on.

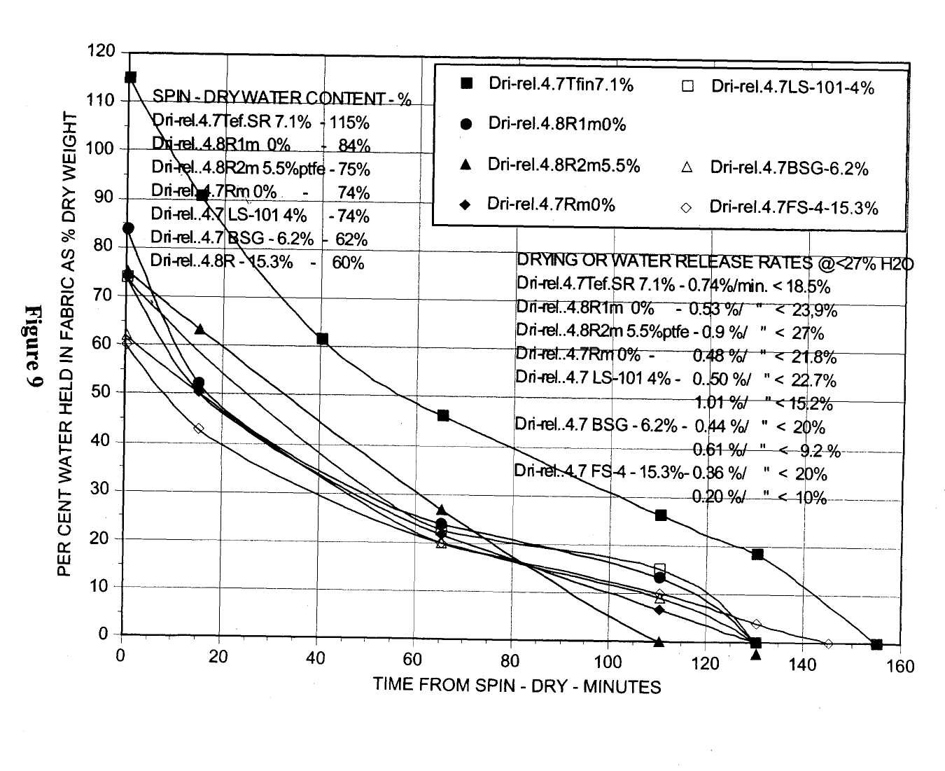

FIG. 9 compares the spin-dry water contents and drying rates of the Dri-Release® samples with the various types of treatment applied. Table 1 compares the spin-dry water contents and water release rate near dryness rates of the samples.

The 5.5% PTFE treated fabric dried so much faster than all of the other fabrics that it went to 0% water at 95 minutes after spin-dry, when the others all had 6-16% more water to lose. Thus, there was no 15 minute before-dryness reading as in the other cases to show any knee in the water release rate near dryness rate curve. Therefore, the calculated water release rate near dryness rate from 27% water down is very conservative, but even so, higher at 0.9% water content per minute than any others over that range. The PTFE treated sample retained water was also reduced from the already low 84% water content of the untreated 4.8 oz./yd² control to 75% water content.

TABLE 1
Example 7 Results

| | | | Water release rate |
|---|---|---|---|
| | Basis | Spin-Dry | near dryness |
| | Weight | Water Content | Rate (% water |
| Sample | (oz./yd²) | (%) | content/minute) |
| Control | 4.7 | 74 | 0.48 |
| Control | 4.8 | 84 | 0.53 |
| 5.5% PTFE | 4.8 | 75 | 0.9 |
| 7.1% Teflon ® Stain | 4.7 | 115 | 0.74 |
| Release | | | |
| 15.3% Fabric Softener | 4.7 | 60 | 0.36 |
| 6.2% Belfasin SG | 4.7 | 62 | 0.44 |
| 4% Stantex LS-101 | 4.7 | 74 | 0.50 |

As shown in FIG., 9 and Table 1, the Dupont Teflon® fluoropolymer hydrophilic stain release treatment at 7.1% add-on gave the most retained water after spin-dry at 115%, but did increase the water release rate near dryness from 0.48% water content per minute for the untreated control to 0.74% water content per minute. The total effect was to increase drying time from 110 minutes for the control to 155 minutes.

The hydrophilic fabric softener FS-4 treatment gave the lowest retained water at 60%, but also gave the lowest water release rate near dryness at 0.36% water content per minute. The FS-4 fabric softener treatment took the next longest drying time at 130 minutes. The Belfasin SG low friction textile softener at 6.2% add-on retained only 62% water and matched the drying time of all but the PTFE treated sample at 110 minutes. The Stantex LS-101 low friction textile finish at 4% add-on gave about the same retained water (74%) as the 5.5% PTFE treatment, and a slightly higher water release rate near dryness (1% v. 0.9%), but about 16% longer drying time because of lower drying rates than the PTFE-treated fabric from about 16% to about 46% water contents.

### Example 8

### Water Release Rates for Treated 100% Polyester Fabrics

2.75 inch diameter disks were punched from washed and unwashed samples of an Insport 3.4 oz/yd² CoolMax® 100% polyester staple t-shirt fabric in a mesh knit, and a 3.8 oz/yd² CoolMax® Alta 100% polyester staple t-shirt fabric with high wicking treatment in a rib-mesh knit. The disks were cut using a standard J.A. King & Co., Inc. 3090AC2 sample cutter.

A water dispersion of PTFE was made close to the goal addition level for each sample by dilution with water from 60% solids Type 30B PTFE (Teflon®) dispersion, available from E.I. Dupont Company. After weighing the disks, the PTFE dispersion was added on the inside surface (side closest to skin in use) of the disk. After five minutes, the excess water was squeezed out of the disks. The disks were then dried using an iron at a low heat setting and the level of treatment was determined after being allowed to equilibrate overnight.

The treated disks along with control samples were then soaked in water. The wet disks were then placed on the sidewalls of a Kenmore heavy-duty washer and spun-dry using the Permanent Press spin-dry cycle. The inside surface of the disks faced away from the sidewall of the washer drum. The disks were weighed immediately after spin-dry to determine the water content of the disks. The disks were kept in a 72° F./43% R.H. environment and weighed in fixed time intervals. Between weighing, the disks were placed on a non-absorbent surface with the inside surface face down. The disks were weighed until dry and water release rates were calculated. The method was validated by doing many tests with reproducible results.

The results are shown in Table 2. Three drying rates are provided, the Drying Rate Near Spin-dry, which represents the rate from spin-dry to about 50% water content; the Mid-Drying Rate, which represents the rate from about 50% water content to about 12% water content; and the Drying Rate Near Dryness, which represents the rate from about 12% water content to dryness.

TABLE 2A
3.4 oz/yd² CoolMax ® 100% polyester staple

| | | | Drying Rate | | Drying Rate |
|---|---|---|---|---|---|
| | Spin-Dry | | Near | Mid | Near |
| | Water | Total | Spin-dry | Drying | Dryness |
| PTFE | Content | Dry time | v. | Rate v. | v. |
| Treatment | v. Control | v. Control | Control | Control | Control |
| (wt %) | (%) | (%) | (%) | (%) | (%) |
| 0.9 | 12.4 | −14.5 | 13 | 15 | 144.7 |
| 0.96 | 5.6 | −15.7 | 9.9 | 10.2 | 124.3 |
| 1.28 | 18.4 | −8.4 | 18.1 | 9.4 | 103.3 |
| 1.34 | 5.9 | −27.7 | 66.2 | 29.1 | 94 |

TABLE 2B
3.8 oz/yd² CoolMax ® Alta 100%
polyester with high wicking treatment

| | | | Drying Rate | | Drying Rate |
|---|---|---|---|---|---|
| | Spin-Dry | | Near | Mid | Near |
| | Water | Total | Spin-dry | Drying | Dryness |
| PTFE | Content | Dry time | v. | Rate v. | v. |
| Treatment | v. Control | v. Control | Control | Control | Control |
| (wt %) | (%) | (%) | (%) | (%) | (%) |
| 0 | 0 | 0 | 0 | 0 | 0 |
| 0.25 | 5.1 | −7.4 | 12.2 | 34.9 | 41.8 |
| 0.485 | 6.3 | 5.2 | −4.5 | −6.5 | 9.9 |
| 1.0 | −7 | −7.4 | −6.8 | −8.8 | 10.25 |
| 1.35 | −4.7 | −28.9 | 27 | 57.3 | 18.7 |

The largest effects of low levels of PTFE treatments on the all polyester fabrics was on the 3.4 oz/yd² CoolMax® 100% polyester staple fabric. The most significant effect is on the drying rate near dryness. The drying rate near dryness is the most important rate because it governs how well an article of clothing releases moisture at water content levels a person experiences during normal wear.

### Example 9

### Water Release Rates for Treated Fabrics

2.75 inch diameter disks were punched from the flat knit uppers and terry bottoms of PRO-FEET Style 85% polyester/15% cotton socks made by Pro-Feet, Inc. The disks were cut using a standard J.A. King & Co., Inc. 3090AC2 sample cutter. A 2% by weight water dispersion of PTFE was made by dilution with water from 60% solids Type 30B PTFE (Teflon®) dispersion, available from E.I. Dupont Company. A 2% by weight water dispersion of polyvinyl acetate/acrylic (PVA/a) was made by diluting a Createx acrylic paint available from the A.C. Moore Co. The Createx PVA/a water dispersion was reduced from 80% to 2% solids. After weighing the disks, the disks were sprayed on the inside surface (side closest to skin in use) with either the 2% PTFE or 2% PVA/a dispersions. Two levels of treatment were applied to the flat knit upper disks and terry bottom disks. The disks were then dried using an iron at a low heat setting on absorbent paper towels and the level of treatment was determined.

The treated disks along with control samples were then soaked in water. The wet disks were then placed on the sidewalls of a Kenmore heavy-duty washer and spun-dry for five minutes using the Permanent Press spin-dry cycle. The inside surface of the disks faced away from the sidewall of the washer drum. The disks were weighed immediately after spin-dry to determine the water content of the disks. The disks were kept in a 72° F./42% R.H. environment and weighed in ten minute intervals. Between weighing, the disks were placed on a non-absorbent surface with the inside surface face down. The disks were weighed for a up to a 6.33 hour period and water release rates were calculated.

After 30 minutes of air drying, all disks were placed in a Kenmore residential dryer set on high heat for 13.5 minutes. The disks were weighed immediately after removal from the dryer. Again the disks were kept in a 72° F./42% R.H. environment and weighed in ten minute intervals. Between weighing, the disks were placed on a non-absorbent surface with the inside surface face down. The disks were weighed until all disks had less than 2% water content.

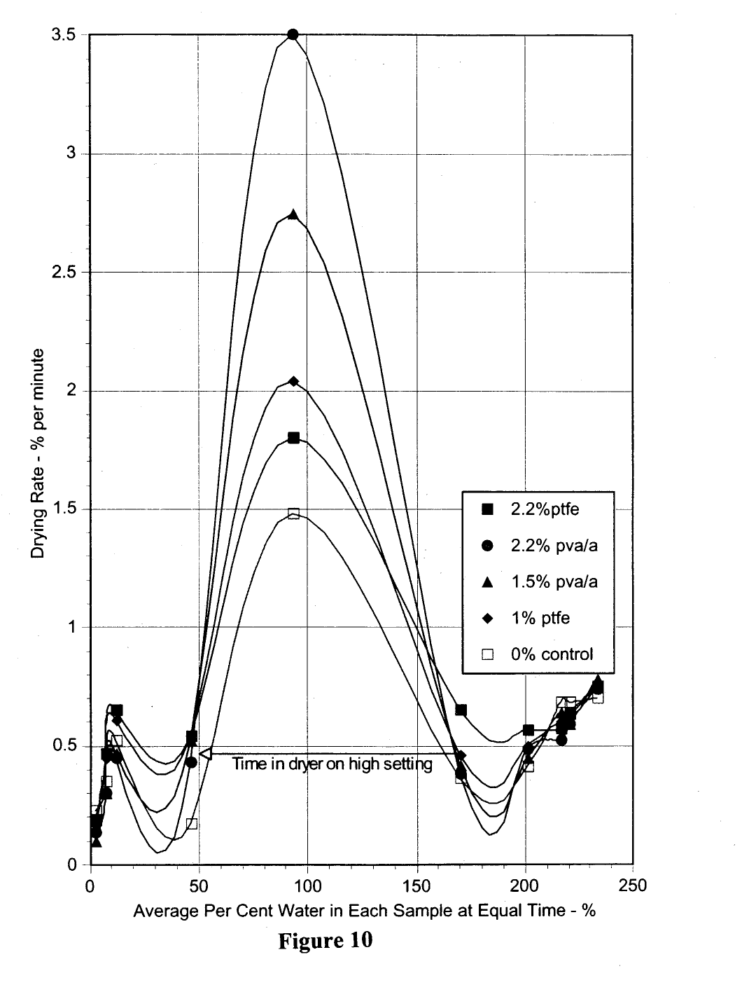

The results are shown in FIGS. 10-13. FIGS. 10-13 report water release rates for each type of disk tested at the average water content for all disks tested. The average water content for all disks tested was used to facilitate comparison between treatment types and levels, and to insure the rates were compared at equal water content levels.

FIG. 10 compares the water release rates of the treated flat knit upper disks with the flat knit upper control disks. The most evident effects in FIG. 10 are that the PVA/a treated disks had much higher water release rates during the 13.5 minute dryer cycle than either the PTFE treated disks or control disks.

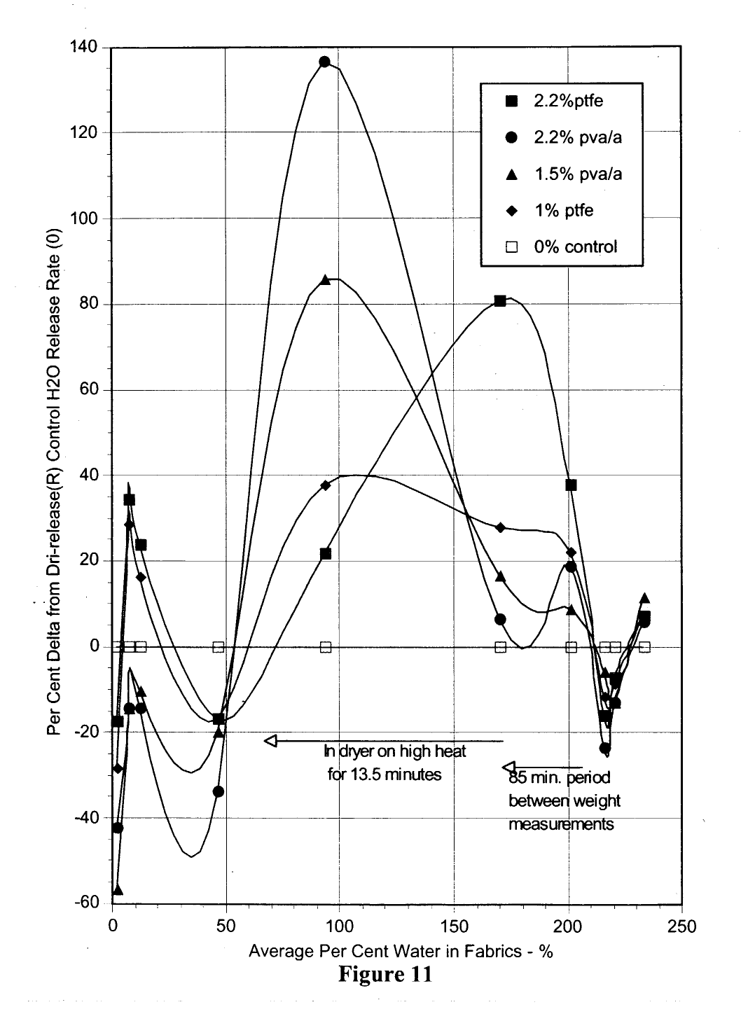

FIG. 11 compares the water release rates of the PTFE and PVA/a treated disks relative to water release rates of an untreated control disk. As shown in FIG. 11, the control and PTFE treated discs lost the least water during the 13.5 minute high heat dryer treatment while the 2.2% PVA/a and 1.5% PVA/a disks lost the most water during this period. The results show that water release rates are very temperature sensitive, and differently so for different treatments. The increased drying rates during the high heat drying period can be very important when considering potential energy savings for residential and commercial dryers.

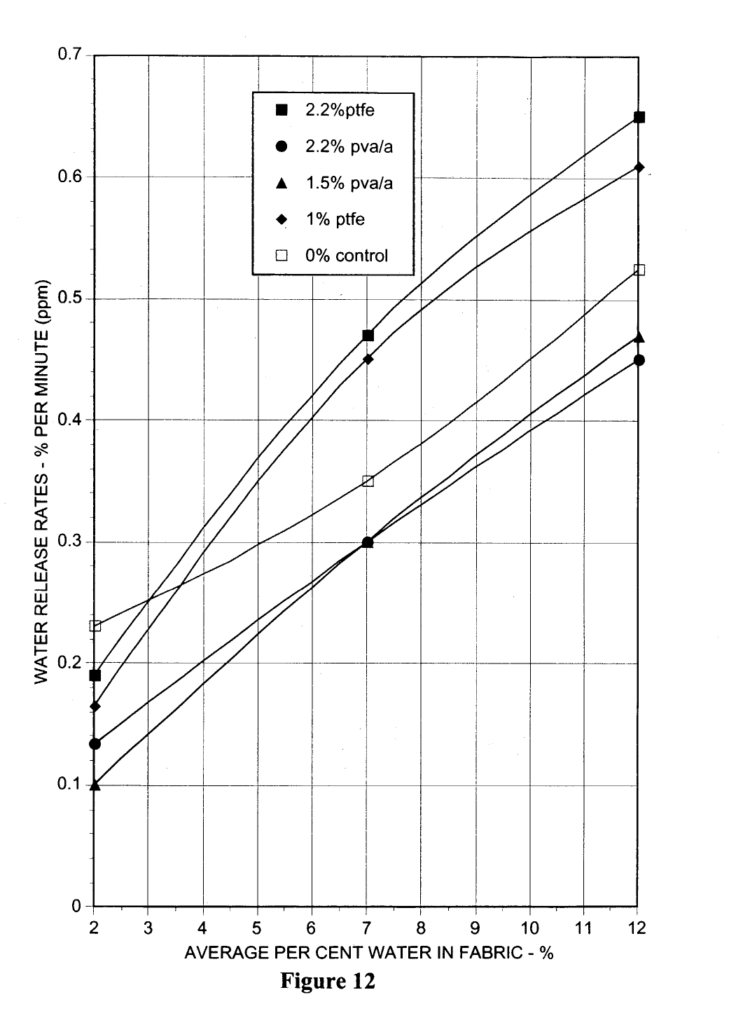

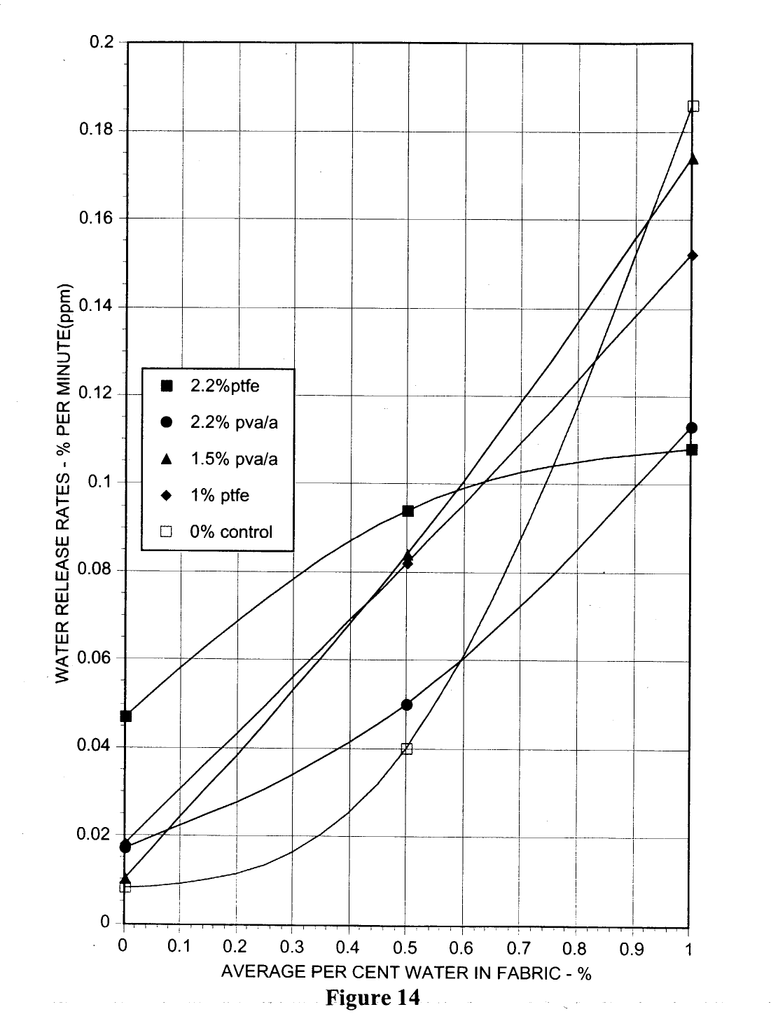

FIG. 12 reports water release rates at low water content for each type of flat knit upper disk tested. Water release rate data points are not shown below 2% average water content, however, FIG. 14 includes the data below 1% water content. As shown in FIG. 12, of the disks tested, the PTFE treated disks had the highest water release rates in the range from about 3% to 12% average water content, where such socks go from feeling dry to feeling wet.

As shown in FIGS. 10-12, the drying times for the flat knit upper disks decreased when either PTFE or PVA/a was added. The untreated (control) flat knit upper disks took 6.33 hours to dry. The flat knit upper disks with 2.2% PTFE took 4.7 hours to dry, or 26% less time to dry than control. The flat knit upper disks with 2.2% PVA/a took 5 hours to dry, or 21% less time to dry than control. The flat knit upper disks with 1% PTFE took 5.33 hours to dry, or 15.8% less time to dry than control. The flat knit upper disks with 1.5% PVA/a took 5.67 hours to dry, or 10.4% less time to dry than control.

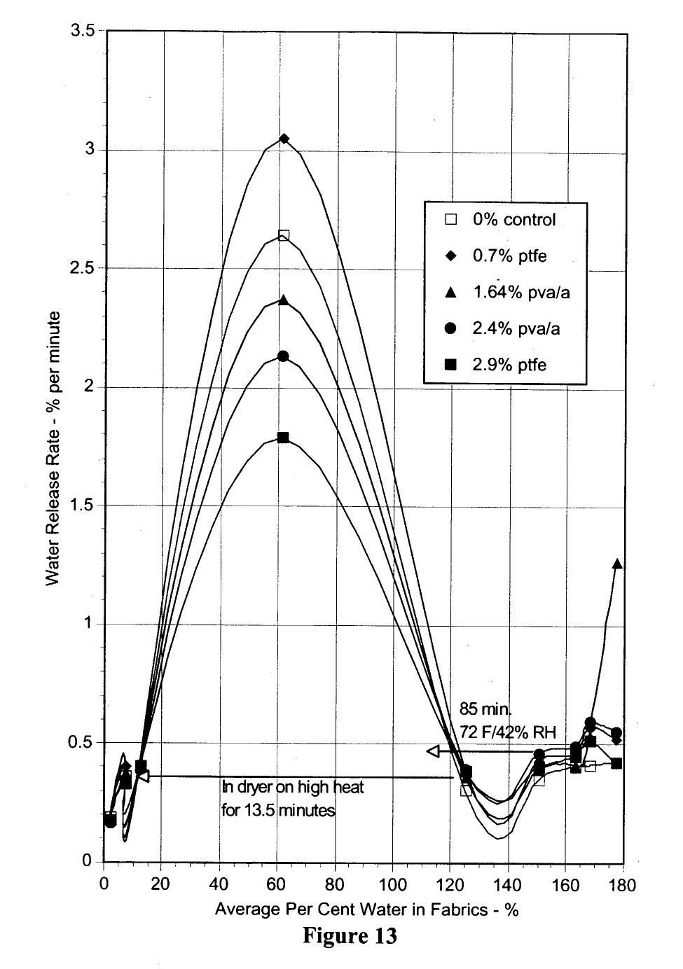

FIG. 13 shows the drying times for the terry bottom disks. As shown in FIG. 13, the drying times for the terry bottom disks increased when either PTFE or PVA/a was added. The untreated (control) terry bottom disks took 3.42 hours to dry. The terry bottom disks with 2.9% PTFE took 3.85 hours to dry. The terry bottom disks with 0.7% PTFE took 4.08 hours to dry. The terry bottom disks with 2.4% PVA/a took 4.33 hours to dry. The terry bottom disks with 1.64% PTFE took 5.15 hours to dry.

All of the terry bottom disks had faster drying times than the flat knit upper disks with comparable treatment. The terry bottom control disk dried 53% faster than the flat knit upper control disk. The terry bottom disks with PTFE dried approximately 23% faster than the flat knit upper disks with PTFE. The terry bottom disks with PVA/a dried approximately 8% faster than the flat knit upper disks with PVA/a.

### Example 10

### User Perceptions of Treated Socks

Socks made from a 85% polyester/15% cotton blend were treated on their inside surface with PTFE and PVA/a dispersions and dried. Test subjects donned a treated sock on one foot and an untreated sock on the other foot. The test subjects commented that, unlike the untreated sock, the treated sock gave a cooling sensation upon donning. These findings are consistent with the higher water release rate data found on test fabrics at or near dryness.

### Example 11

### Water Release Rates For Treated Fabrics at Low Water Contents

The flat-knit upper and terry bottom disks from Example 9 were tested again to better determine their behavior at water content levels below 2%. The inside surfaces of the disks were sprayed lightly with water to obtain approximately 30-40% water content. The disks were kept in a 72° F./42% R.H. environment and weighed in ten minute intervals. Between weighing, the disks were placed on a non-absorbent surface with the inside surface face down. The disks were weighed until all disks reached their dry weight.

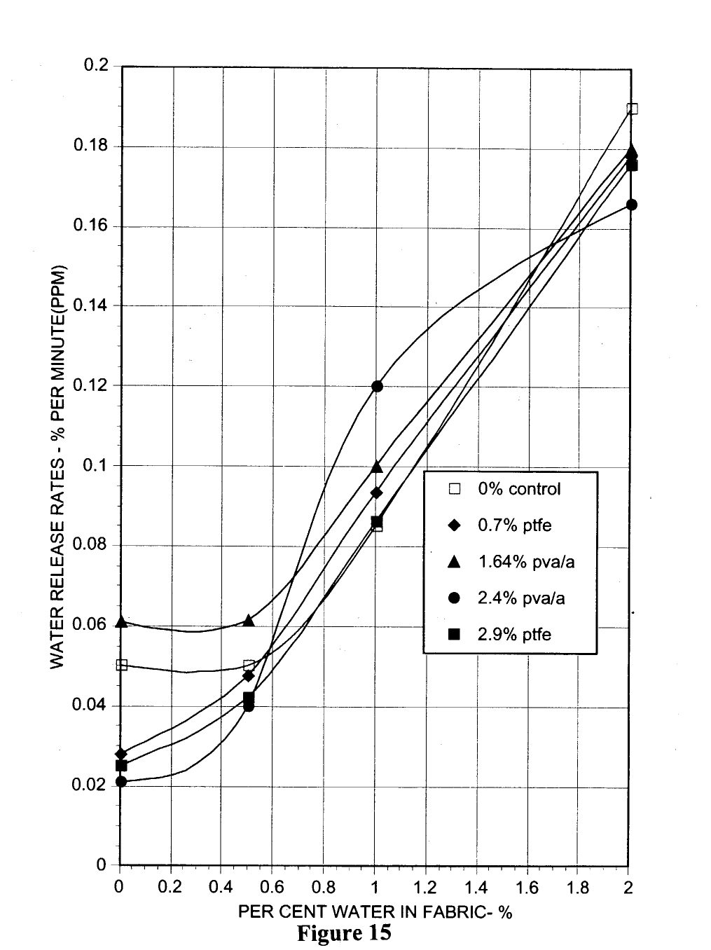

The results are shown in FIGS. 14 and 15. FIG. 14 compares the water release rates of the PTFE and PVA/a treated flat knit upper disks at water content levels below 1%. As shown in FIG. 14, when the average water content is below 0.6%, the treated flat knit upper disks have higher water release rates than untreated flat knit upper disks. These results correlate generally with the subjective responses of wearers from Example 10.

FIG. 15 compares the water release rates of the PTFE and PVA/a treated terry bottom disks at water content levels below 2%. As shown in FIG. 15, the PVA/a treated disks had higher water release rates than control around 1% water content. The 0.7% PTFE treated disk had slightly higher water release rates than control around 1% water content.

### Example 12

### Effects of Repeated Soakings and Drying Cycles—2 Spin Cycles

The terry lower disks from Examples 9 and 11 were tested again using the same method used in Example 9, except the inside surface of the disks faced toward the sidewall of the washer drum.

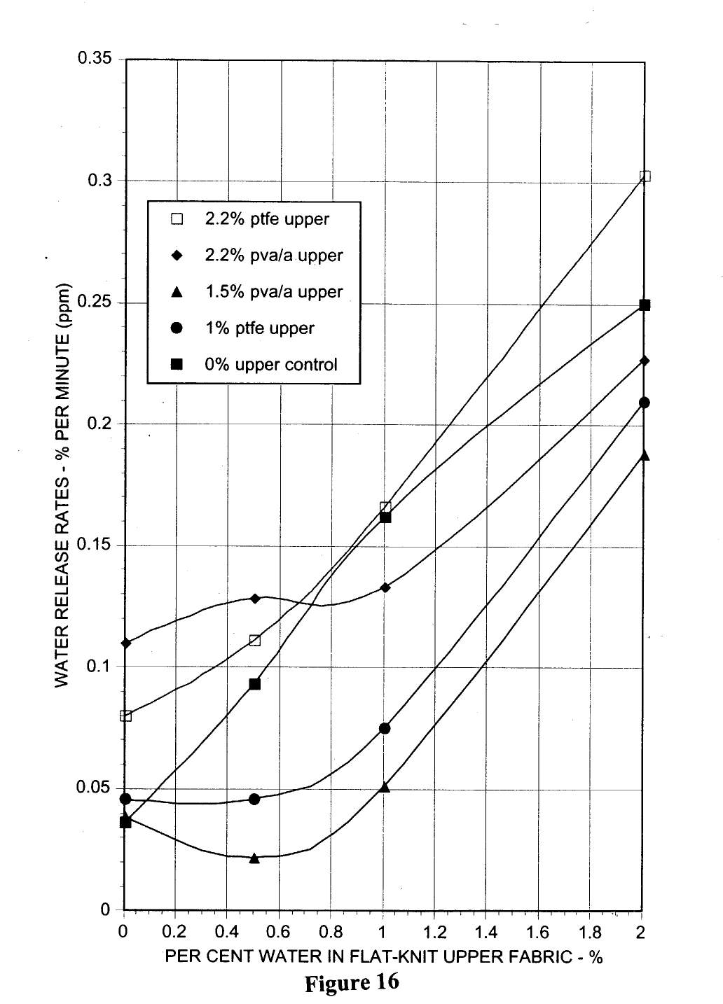

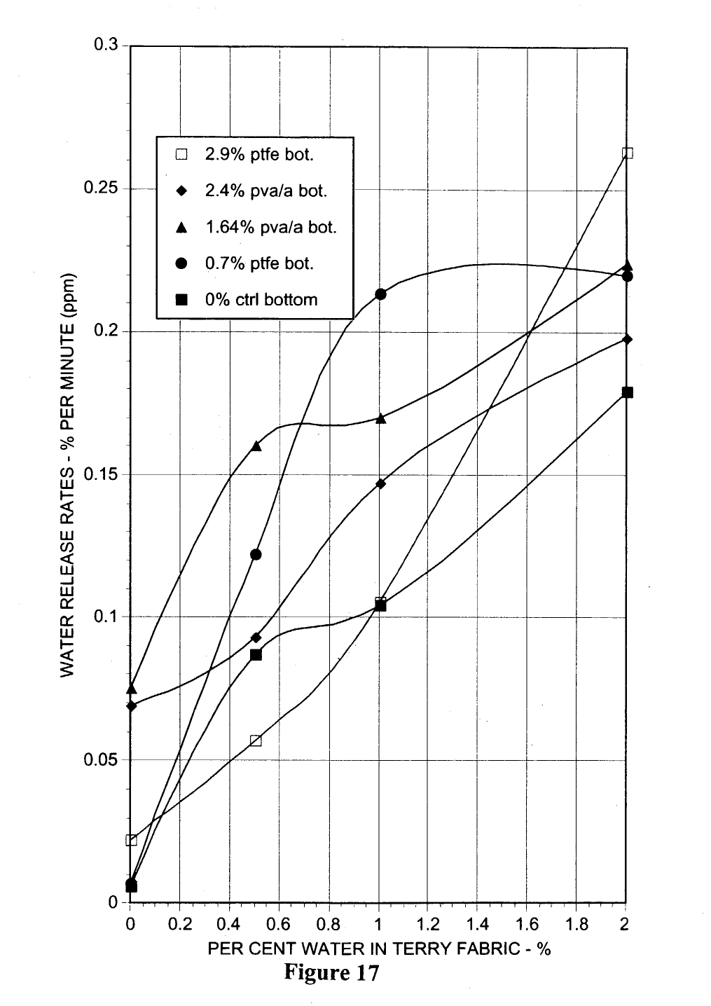

The results are shown in FIGS. 16 and 17. FIG. 16 compares the water release rates of the PTFE and PVA/a treated flat knit disks at water content levels below 2%. As shown in FIG. 16, the water release rate near zero water content was higher for treated flat-knit upper disks than for control flat-knit upper disks. The water release rates for the 2.2% PVA/a treated flat-knit upper disks were about 2×those of the control flat-knit upper disks. The water release rates for the 2.2% PTFE treated flat-knit upper disks were about 1.25× those of the control flat-knit upper disks. FIG. 16 also shows that the water release rates for 2.2% PVA/a treated flat-knit upper disks improved at low water content levels after the third wetting and drying cycle. The improvements can be seen by comparing the results in FIG. 16 with FIG. 14.

FIG. 17 is a graphical plot comparing water release rates of PTFE and PVA/a treated terry socks at water content levels below 2%. As shown in FIG. 17, the water release rate near zero water content was higher for treated terry lower disks than for control terry lower disks. The water release rates for the 1.64% and 2.4% PVA/a treated terry lower disks were about 10× those of the control terry lower disks. The water release rates for the 2.9% PTFE treated terry lower disks were about 3× those of the control terry lower disks.

### Example 13

### Effects of Repeated Soakings and Drying Cycles—3 Spin Cycles

The terry lower disks from Examples 9, 11, and 12 were tested again using the same method used in Example 9, with the inside surface of the disks faced away from the sidewall of the washer drum.

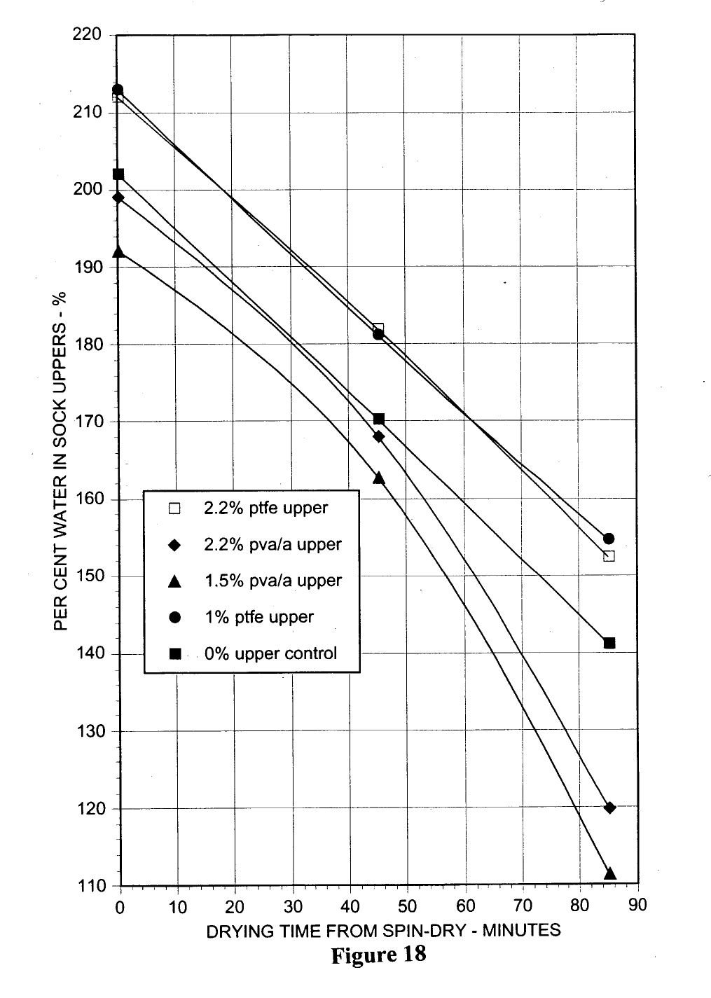

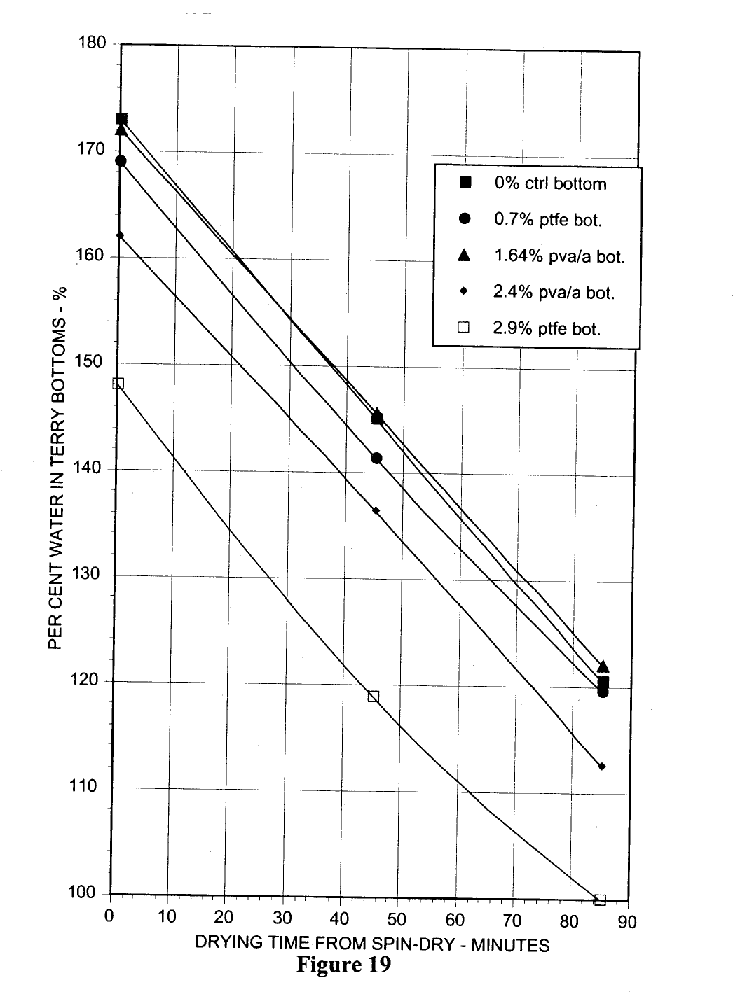

The results are shown in FIGS. 18-21. FIG. 18 shows the water content of the flat knit upper disks as a function of time elapsed since removal from the spin-dry cycle. As shown in FIG. 18, the water release rates for the disks treated with PVA/a increased as the drying occurred (i.e. steeper slopes). FIG. 19 shows the water content of the terry lower disks as a function of time elapsed since removal from the spin-dry cycle.

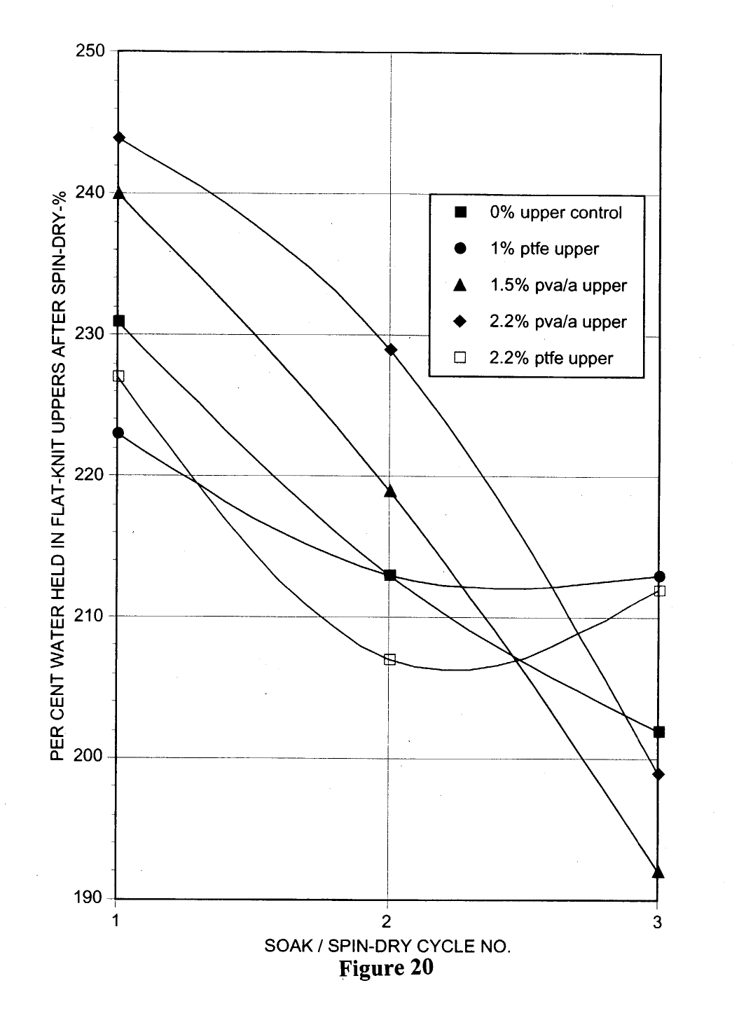

FIG. 20 shows that the water content upon removal from the five minute spin-dry cycle for each of the three spin-dry cycles for the flat-knit upper disks. As shown in FIG. 20, the flat-knit upper disks with PTFE had slightly less water content upon removal from the spin-dry cycle than the control disks after the first spin-dry cycle. The flat-knit upper disks with PVA/a have slightly more water content upon removal from the spin-dry cycle than the control disks after the first spin-dry cycle. The flat-knit upper disks with PVA/a, however, have less water content upon removal from the spin-dry cycle than the control disks after the third spin-dry cycle.

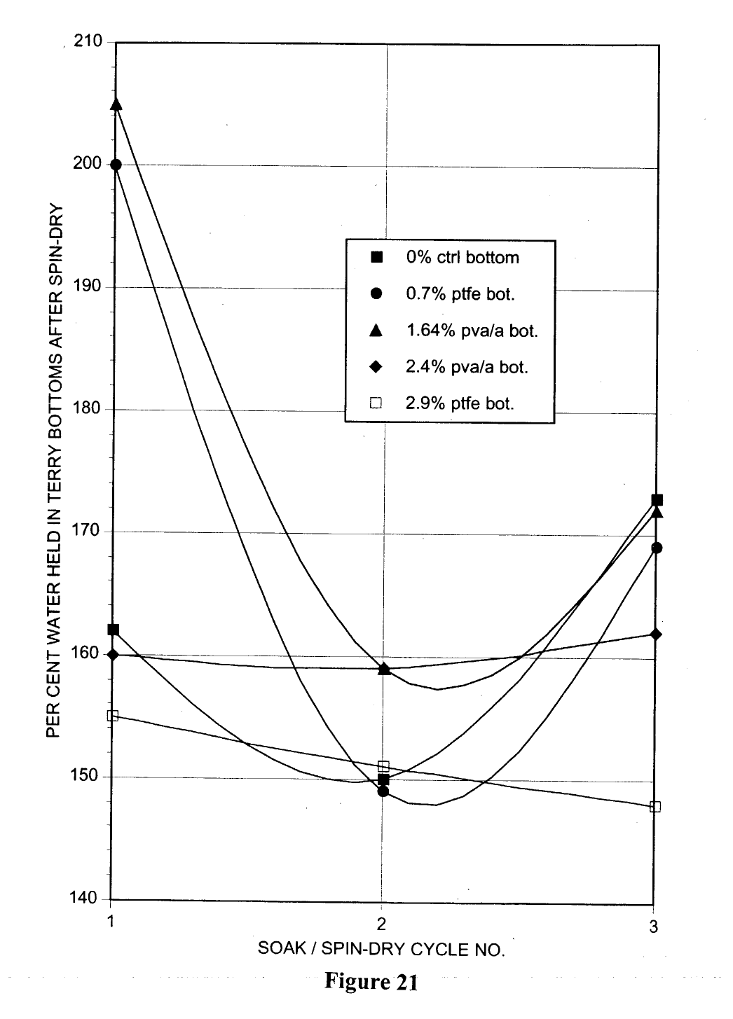

FIG. 21 shows that the water content upon removal from the five minute spin-dry cycle for terry lower disks treated with lower levels of PTFE and PVA/a was lower after the third spin-dry than it was after the first spin-dry. As shown in FIG. 21, the 0.7% PTFE terry lower disks and 1.64% PVA/a terry lower disks held about 16% less water after the fourth wetting and third spin-dry when compared to the water content after the first wetting and spin-dry cycle. As a result, all of the treated bottoms held less water than the control after the third spin-dry cycle.

### Example 14

### Friction Properties of PVA and PVA/a Treated Socks

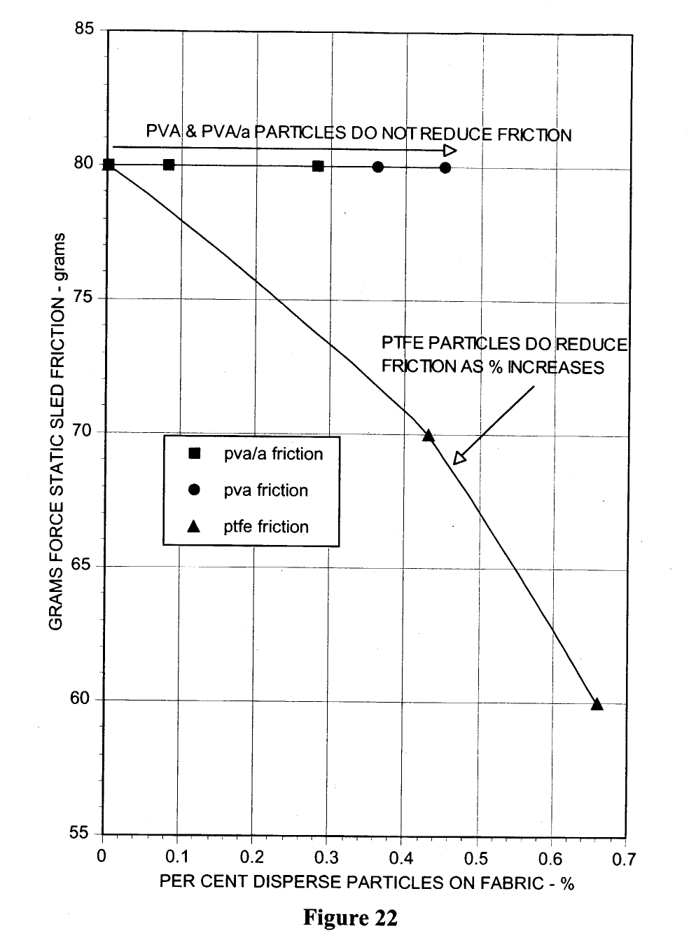

The friction properties of a t-shirt fabric treated with various levels of PVA, PVA/a, and PTFE were tested using the same method described in Example 5. The t-shirt fabric was made from 50% polyester and 50% cotton yarns. FIG. 22 compares the friction properties of the fabrics tested. As shown in FIG. 22, very small amounts of PTFE reduces the friction of the t-shirt. Significantly, the PVA and PVA/a treatments do not affect the t-shirt's friction properties.

### Example 15

### Effects of Low PTFE Levels on Socks During Use

Quarter socks knit by Willowbrook Hosiery, Burlington, N.C., USA from 85% Wellman Comfortrel® polyester staple and 15% cotton staple yarn from Beal Mfg., Ranlo, N.C. were used as test and control in this experiment. The test sock was treated on the inside with 0.1% Type 30B polytetrafluoroethylene (PTFE) Teflon® applied from a 0.2% dilute dispersion in water, which was made from the 60% solids dispersion available from E.I. Dupont Company. The control had no treatment. These liner socks had been prepared seven months prior to the wear test, and worn, washed and dried at least five times during that period.

All four socks were weighed at 70° F., 40% RH indoors on a precision electronic scale before donning. The test sock was worn on one foot and the control on the other foot. 100% cotton crew socks were then donned over the test socks to simulate a winter wear condition. Tightly laced, low walking shoes were worn for two one mile walks of 15 minutes each in 40° F. outdoor conditions with a 30 minute rest between segments.

At the end of the second mile, the shoes and socks were removed one foot at a time and the socks reweighed immediately after removal. The test socks and crew over-sock had picked up only 0.22% and 0.34% respectively. The 0.1% PTFE treated sock held 0.62% perspiration and the crew sock held 0.56% perspiration, or 2.8× and 1.65× as much as the untreated socks after this mild exercise. The test subject commented that the foot with the treated sock had a less constrained, floating feeling during walking and the foot with the untreated sock had a hotter, prickly feeling. The absorbent lining of the shoes may have picked up some perspiration that was not measured.

### Example 16

### Effects of Low PTFE Levels on Socks During Vigorous Exercise

Using the socks and methodology of Example 15, a test subject again donned the socks with crew over-socks and performed exercises. This time, the exercises were more vigorous and were performed in less absorbent K-Swiss tennis shoes. The one and a half hour aerobic exercise routine included a four miles per hour treadmill, bicycling, and stair-climbing segments. Again the test subject commented that the foot with the treated liner had a cooler, less “prickly” feeling throughout the exercises. The foot with the untreated liner sock began to feel wetter than the treated sock foot within fifteen minutes. The difference in wetness between the two feet became increasingly more pronounced as the exercise continued. The K-Swiss tennis shoes and the socks were removed and the socks all weighed immediately as done previously. In this more extreme test, the treated liner sock only held 0.2% perspiration, but the cotton crew over-sock held 13.2% perspiration (2.9 grams). The test subject commented that the foot with the treated liner felt dry. The untreated liner sock held less than 0.1% perspiration and the outer cotton crew held only 1% perspiration. The untreated liner sock did not transfer the perspiration generated in the exercise to the outer sock nearly as well as the treated liner sock.

Since the 2.9 grams of perspiration moved to the outer sock seemed large in this more vigorous test, 3 milliliters (approx. 3 grams) of soapy water was applied to one foot of the tester. The 3 milliliters was found to form a sweat-like layer comparable to the wetness the test subject experienced with the untreated sock after the more vigorous exercising.

### Example 17

### Spin-Dry Water Content of Various Hydrophobic Treatments

The purpose of this example was to determine whether hydrophobic particle treatments at a low concentration would reduce the spin-dry water contents and/or increase water release rates for several different types of performance fabric, despite their different forms and amounts of hydrophilic and hydrophobic surfaces.

Various fabrics were tested to determine their spin-dry water contents with treatments of PVA/a, PVA, and PTFE. Fabric 1 was 4.8 oz/yd² CoolMax® Alta 100% polyester with a non-durable hydrophilic finish. Fabric 2 was 4.6 oz/yd² Akwatek® 100% polyester with a more durable chemical treatment applied during finishing that converts some of the chemical groups on the surface into more hydrophilic types. Fabric 3 was a 5.7 oz/yd² Dri-release® fabric having an intimate blend of 15% hydrophilic cotton fibers and 85% of co-polyester fibers, which gives a permanent combination of hydrophilic and hydrophobic elements. Because the basis weight of the fabric affects the drying and water release results, 5.0, 4.7, and 4.0 oz/yd² fabrics from M.J. Soffe Inc. (Fayetteville, N.C.) of the same poly/cotton blend type as Fabric 3 were tested. Fabrics 1, 2, and 3 were from Duofold, a division of Sara Lee Corp. (Chicago, Ill.). Fabrics from different sources are likely to have a different finish applied as received, which affects water held until the finish is removed by repeated washings.

The test procedure in all steps was to treat the fabrics together and then spin-dry them all on the inner surface of a Sears Kenmore 70 Series Heavy Duty Plus Model 110 washing machine. The fully wetted fabric discs were placed on the inner surface of the washer drum and would stay in place due to their excess water throughout the spin cycle. The centrifugal force of the spin cycle gave all samples the same water reduction treatment so that differences in the water content of the samples at the end of the spin cycle provided a measure of the comparative water holding performance of the fabrics under typical machine washing conditions, and established the starting water content for air or heated drying.

Some samples of each fabric type were treated by spraying them on the inside with 0.2% by weight water dispersions of various hydrophobic polymers to a total weight equal to the dry fabric weight. In all cases the actual dry weight pickup was close to 0.17%. The spin-dry water content for each of the samples is shown in Table 3.

TABLE 3
Spin-dry water content with 0.17% treatment levels

| | | | Spin-dry Water |
|---|---|---|---|
| | Basis Weight | | Content |
| Sample | (oz/yd²) | Treatment Type | (%) |
| CoolMax ® Alta | 4.8 | None | 95.9 |
| CoolMax ® Alta | 4.8 | PVA/a | 70.9 |
| CoolMax ® Alta | 4.8 | PVA | 61.8 |
| CoolMax ® Alta | 4.8 | PTFE | 64.5 |
| Akwatek ® | 4.6 | None | 114 |
| Akwatek ® | 4.6 | PVA/a | 71.7 |
| Akwatek ® | 4.6 | PVA | 56.1 |
| Akwatek ® | 4.6 | PTFE | 44.1 |
| Dri-release ® fabric | 4.0 | None | 112.7 |
| Dri-release ® fabric | 4.0 | PTFE | 58.2 |
| Dri-release ® fabric | 4.7 | None | 68.7 |
| Dri-release ® fabric | 4.7 | PTFE | 60.5 |
| Dri-release ® fabric | 5.0 | None | 91 |
| Dri-release ® fabric | 5.0 | PVA/a | 68 |
| Dri-release ® fabric | 5.0 | PVA | 71 |
| Dri-release ® fabric | 5.7 | None | 82.3 |
| Dri-release ® fabric | 5.7 | PVA/a | 72.8 |
| Dri-release ® fabric | 5.7 | PVA | 65.9 |
| Dri-release ® fabric | 5.7 | PTFE | 62.9 |

In general, Table 3 shows that PVA/a, PVA, and PTFE, applied at 0.17% by weight reduces the water held after spin-dry for all of the as-received fabrics but to different amounts for each treatment type, weight, and finish. In general, the higher the water held in the untreated fabric, the effect of the treatment became more pronounced. This effect tends to bring all of the fabrics to a similar low level for fabrics treated with PVA/a. The effect with PVA is greater yet, such that the highest spin-dry water content level for an untreated fabric becomes the lowest, lower than any PVA/a fabric. The effect with PTFE is even more exaggerated, and reduces the highest untreated fabric to the lowest spin-dry water content level of all the tested fabrics.

All of the hydrophobic dispersions significantly reduced spin-dry water content levels far more than expected for the small amounts applied.

### Example 18

### Spin-Dry Water Content of Various Hydrophobic Treatments After Washing of Hydrophilic Finished Polyesters

The samples from Example 17 were washed once with Tide home detergent and spun dry. This increased spin-dry water content levels for all the samples.

### Example 19

### Spin-Dry Water Content of Various Hydrophobic Treatments After Repeated Washings of Hydrophilic Finished Polyesters

The samples from Example 18 were then further washed 10 times with IEC Phosphate Reference Detergent(B) specified for use in British Standards Institute BS EN 26330:1994 for “Domestic washing and drying procedures for textile testing”(ISO 6330:1984). This washing was done to remove all temporary finishes and wetting agents to see if the effect of the hydrophobic treatments would persist.

TABLE 4
Spin-dry water content with 0.17% treatment
levels after repeated washings

| | Basis Weight | | Spin-dry |
|---|---|---|---|
| Sample | (oz/yd²) | Treatment Type | Water Content (%) |
| CoolMax ® Alta | 4.8 | None | 92.2 |
| CoolMax ® Alta | 4.8 | PVA/a | 85.9 |
| CoolMax ® Alta | 4.8 | PVA | 86.1 |
| Akwatek ® | 4.6 | None | 67.9 |
| Akwatek ® | 4.6 | PVA/a | 65.8 |
| Akwatek ® | 4.6 | PVA | 68.4 |

As shown in Table 4, the surface-modified Akwatek® polyester fabric changed the most after washing. It dropped from the highest spin-dry water content at 114% (see Table 3) to the lowest at 67.9% without any treatment. The Akwatek® polyester fabric with 0.17% PVA/a treatment dropped from 72% to 66% spin-dry water content after washing. The PVA treated Akwatek® increased from 56% to 68% spin-dry water content after repeated washing. These results suggest that the Akwatek® fabric has a highly hydrophilic non-durable finish as received and is largely hydrophobic after this is washed away.

The treatments had little or no effect on the spin-dry water content levels for Akwatek® after repeated washings. A reduction in spin-dry water content levels was observed on the CoolMax® Alta fabrics.

### Example 20

### Combined Treatments of Various Hydrophobic Dispersions

The PVA and PVA/a samples from Example 19 were further treated with 0.17% PTFE. The results are shown in Table 5.

TABLE 5
Spin-dry water content with 0.17% treatment levels of
PVA or PVA/a and further treatment with 0.17% PTFE

| | | | Spin-dry Water |
|---|---|---|---|
| | Basis Weight | | Content |
| Sample | (oz/yd²) | Treatment Type | (%) |
| CoolMax ® Alta | 4.8 | PVA/a | 66.1 |
| CoolMax ® Alta | 4.8 | PVA | 68 |
| Akwatek ® | 4.6 | PVA/a | 56.6 |
| Akwatek ® | 4.6 | PVA | 64.9 |
| Dri-release ® fabric | 5.0 | PVA/a | 58.6 |
| Dri-release ® fabric | 5.0 | PVA | 74 |
| Dri-release ® fabric | 5.7 | PVA/a | 60.4 |
| Dri-release ® fabric | 5.7 | PVA | 85.7 |

Spin-dry water content reductions were observed in all combinations. The combination of PVA and PTFE treatments on Akwatek® fabric reduced spin-dry water content from 66% to 57%. The greatest effect of the additional PTFE treatment was on the PVA/a treated 5.7 oz/yd² Dri-release® blend fabric, which was reduced from 96% to 60% spin-dry water content.

These results are significant because they show that low level treatments of hydrophobic dispersed particles can make fabrics with various hydrophilic elements release water much more than expected in a standard home or commercial spin-centrifuge process. This helps to reduce the amount of water that must be removed in expensive heat or slow air-drying steps. A further finding was that combinations of different types of hydrophobic particles can give greater and more durable effects than using a single treatment type.

### Example 21

### Water Release Rates of Performance Fabrics

This example shows that surprisingly small amounts of hydrophobic dispersed particles greatly increases the water release rate of fabrics, even high performance fabrics such as CoolMax® Alta, Akwatek®, and Dri-release® fabrics. Four sample types similar to those prepared for Example 17 were prepared and tested. The four fabric sample types were: 1) 4.8 oz/yd² CoolMax® Alta 100% polyester with a non-durable hydrophilic finish; 2) 4.6 oz/yd² Akwatek® 100% polyester with a more durable chemical treatment applied during finishing that converts some of the chemical groups on the surface into more hydrophilic types; 3) 5.7 oz/yd² Dri-release® fabric having an intimate blend of 15% hydrophilic cotton fibers and 85% of co-polyester fibers which gives a permanent combination of hydrophilic and hydrophobic elements; and 4) 5.0 oz/yd² Dri-release® fabric having an intimate blend of 15% hydrophilic cotton fibers and 85% of co-polyester fibers.

Water release rates were measured using procedures comparable to those described in Example 9 above. The water release rates of the fabrics as-received are shown in Table 6.

TABLE 6
Water release rates of fabrics as received.
Values reported in water content % change per minute.

| | | | Dri-release ® | Dri-release ® |
|---|---|---|---|---|
| | CoolMax ® Alta | Akwatek ® | 5.7 oz/yd² | 5.0 oz/yd² |
| @45% (±10%) | 1.035 ± 0.015 | 0.749 ± 0.112 | 1.028 ± 0.008 | 1.054 ± 0.024 |
| water content | | | | |
| @5-10 | 0.1625 ± 0.05 | 0.38 ± 0.06 | 0.502 ± 0.085 | 0.699 ± 0.087 |
| minutes from | | | | |
| dryness | | | | |

As shown in Table 5, the four fabrics all have high water release rates as received with hydrophilic finishes undisturbed. Table 5 also shows how much lower all water release rates are near dryness before any wash has been performed or treatment applied. The hydrophilic-modified CoolMax® Alta and Akwatek® fabrics tend to have low water release rates compared to the Dri-release® fabrics near dryness.

### Example 22

### Effects of Hydrophobic Particle Treatments on Water Release Rates

Another variable is the use of fugitive textile finishes to improve the softness and wicking of fabrics in the initial handling by customers. These are removed usually in a single washing, so they do not persist in the fabrics or garments in actual use. The fabrics from Example 21 were washed one time with Tide, which contains hydrophilic wetting agents. The Tide wash removes some of the non-durable softeners and finishes applied by the textile manufacturers.

The four types of fabric were then treated with PVA, PVA/a, and PTFE dispersions and dried. In all cases the actual dry weight pickup was close to 0.17%. Water release rates were then measured for each of the fabrics with and without the various treatments. The results are shown in Table 7.

TABLE 7
Water release rates 5 to 20 minutes from drying after a single
washing in Tide. Values reported in water content % change
per minute.

| | | | | Dri- |
|---|---|---|---|---|
| | CoolMax ® | | Dri-release ® | release ® |
| Sample | Alta | Akwatek ® | 5.7 oz/yd² | 5.0 oz/yd² |
| Untreated | 0.492 | 0.453 | 0.342 | 0.390 |
| 0.17% PVA | 0.386 | 1.07 | 0.446 | 0.512 |
| 0.17% PVA/a | 0.594 | 0.708 | 0.756 | 1.05 |

As shown by comparing the untreated fabrics in Table 7 with the results in Table 6, each fabric is affected differently by the first washing, the hydrophilic-surfaced CoolMax® Alta and Akwatek® fabrics of 100% polyester benefit, while the Dri-release® fabrics have reduced water release rates.

As shown in Table 7, if the fabrics are treated with small (0.17% by weight) amounts of hydrophobic dispersed particles like PVA or PVA/a before the Tide wash, their water release rates near dryness after washing are improved much more than would be expected from the small amount of treatment applied.

The water release rate of the CoolMax® Alta coated polyester was improved by the PVA/a treatment, but was reduced by the PVA treatment. The CoolMax® Alta fabric was the only fabric tested with a water release rate reduced by a treatment. Table 8, below, however, shows that CoolMax® Alta sample with PVA treatment improved the most after repeated washings. This suggests that the textile finish may have remained present after the single washing and influenced the results.

The water release rate of the Akwatek® surface-modified polyester was most improved by the PVA treatment, but was also improved by the PVA/a treatment. Both of the Dri-release® polyester/cotton blends were improved significantly by the PVA treatment, but even more significantly by the PVA/a treatment. A comparison of the Dri-release® suggests that optimum treatment levels depend on the basis weight of the fabric.

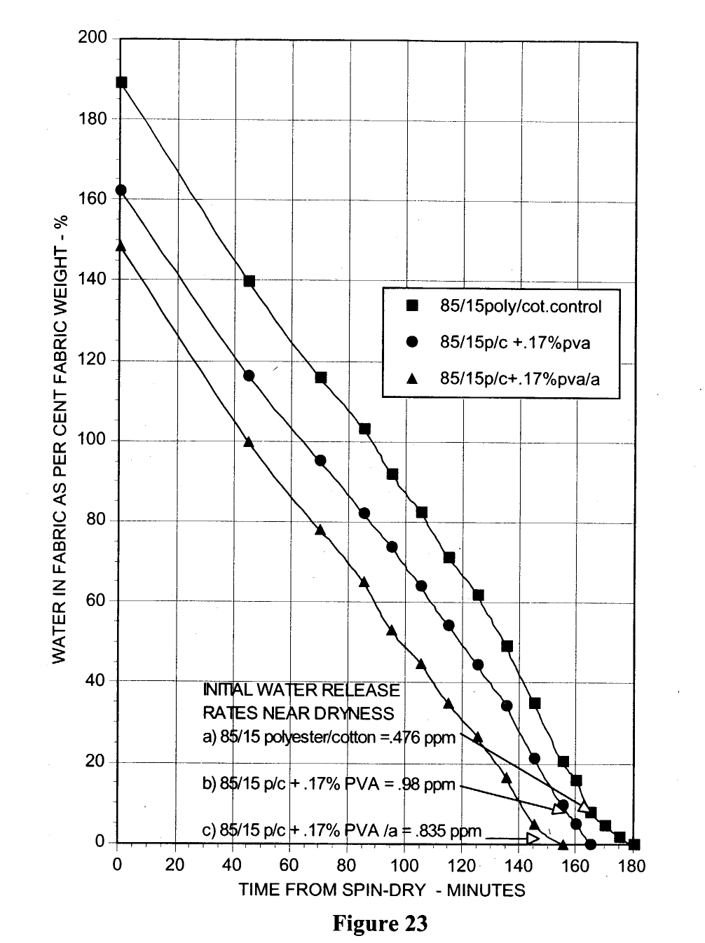

FIG. 23 compares the drying time test results of the 5.0 oz/yd² Dri-release® fabric left untreated, treated with 0.17% PVA, and treated with 0.17% PVA/a particles. As shown in FIG. 23, the untreated fabric has the highest spin-dry water content. The PVA and PVA/a treatments reduce the spin-dry water content levels by 14% and 22%, respectively. FIG. 23 also shows how the final 15 minute drying rates of the treated fabrics are increased 2.06× and 1.75×, respectively, versus the untreated fabric. The treated fabrics' spin-dry water content and overall drying times are also reduced significantly, even though their manufacturer applied hydrophilic finish, which caused such high water content levels, has not been washed off.

### Example 23

### Effects of Hydrophobic Particle Treatments on Water Release Rates After Repeated Washings

The fabric samples from Example 22 were washed 10 times with the British Standards IEC detergent, without softeners or wetting agents. After the washings, water release rates for the fabrics were measured. The results are shown in Table 8.

TABLE 8
Water release rates 10 minutes from drying after 11 washings.
Values reported in water content % change per minute.

| | | | | Dri- |
|---|---|---|---|---|
| | CoolMax ® | | Dri-release ® | release ® |
| Sample | Alta | Akwatek ® | 5.7 oz/yd² | 5.0 oz/yd² |
| Untreated | 0.149 | 0.818 | 0.626 | 0.581 |
| 0.17% PVA | 0.744 | 0.822 | 0.913 | 0.761 |
| 0.17% PVA/a | 0.543 | 1.224 | 0.914 | 0.622 |
| 0.17% PTFE | 1.005 | 1.057 | 0.706 | 1.228 |

As shown in Table 8, the various treatments improved the water release rates of all four fabrics after 10 additional washings.

As made evident by comparing Table 8 with Table 7, the water release rates of the untreated CoolMax® Alta and Akwatek® 100% polyester fabrics were reduced after the 10 washings. The water release rates of the untreated Dri-release® 85/15 polyester/cotton fabrics were improved by the 10 washings.

### Example 24

### Water Release Rates Compared to Perspiration Output

The estimated average daily output of perspiration from the upper body under a typical 100 to 150 gram t-shirt is 0.16 to 0.24 percent of fabric weight per minute. Active exercise output will be from 0.8 to 1.2 percent of fabric weight per minute. (Information from Altruis Biomedical Network, which is publicly available through the internet at the world wide web at, for example, sweating.net and media.mit.edu)

All of the test fabrics used in Examples 21-23, except CoolMax® Alta, will release water at higher rates 5-10 minutes from dryness prior to washing, but none of the tested fabrics prior to washing or after 1 wash release water fast enough to keep up with rate perspiration is generated during active exercise. The untreated CoolMax® Alta fabric fails to release water at even the daily average rate after 11 washes, while the Akwatek® fabric does and the untreated Dri-release® fabrics approach that rate. The Akwatek® and 5.7 oz/yd² Dri-release® fabrics release water at a rate above the moderate exercise rate when treated with PVA, PVA/a, or PTFE particles. Both CoolMax® Alta and 5.0 oz/yd² Dri-release® fabrics approach the 0.80 percent of fabric weight per minute of active exercise rate when treated with PVA, but are lower with the PVA/a treatment.

Further, after repeated washings, the CoolMax® Alta 100% polyester fabric, with its hydrophilic finishes removed, released water in the first 15 minutes of wear at as slow as ⅕th the moderate exercise sweat output rate. This means that water will build up in the fabric leading to a wet feeling and, in cool weather, possibly hypothermia. The highest water content at 15 minutes in the above cases is 6%, which is already approaching the threshold of a wet fabric feel. The other fabrics continue to release moisture at above the average daily rate and fast enough for moderate exercise, but not enough to keep fabrics dry during long term active exercise (e.g. running) except for PVA/a treated Akwatek® fabric and PTFE-treated 5.0 oz/yd² Dri-release® fabric after 11 washes. The Akwatek® fabric treated with PVA and 5.0 oz /yd² Dri-release® fabric treated with PVA/a approach the rate for active exercise after 1 Tide washing.

All of the untreated fabrics have water release rates that are less than the average sweat output in the first 5 minutes from dryness. This causes the initial sensation of donning a dry garment to be of an increased humidity and skin temperature. This is an important deficiency corrected by the hydrophobic dispersion treatments of the present invention. For all of the fabrics in the Example, the time when they reach full dryness at zero time is defined as the time they reach less than 0.5% water contents. The effect of an increased water release rate from dryness is to give a cooling effect when a garment is first donned versus the same fabric without the treatment. This cooling has been confirmed by subjective tests on lightweight hosiery and socks. It seems to persist in wearing even during exercise to reduce the hot and tingling sensation of the skin often felt during exertion in conventional fabrics.

### Example 25

### Analysis of Results From Examples 21-24

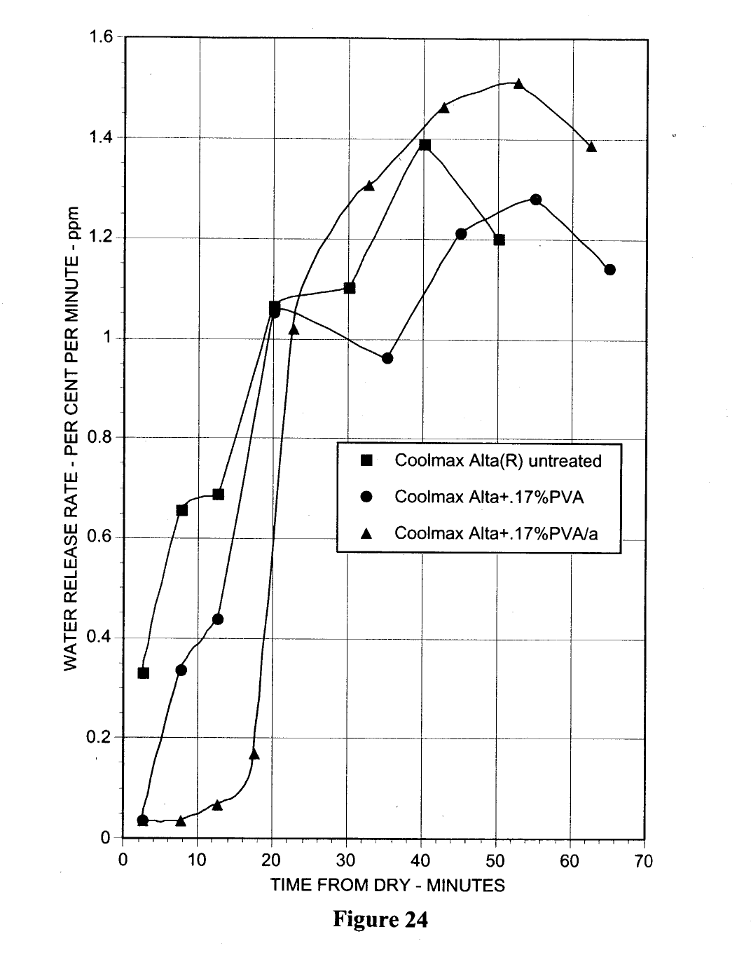

FIG. 24 shows the water release rates versus time from dryness for the unwashed CoolMax® Alta fabric untreated and treated with 0.17% PVA, or with 0.17% PVA/a particles. As shown in FIG. 24, the unwashed CoolMax® Alta fabric has both textile finishes and hydrophilic coating undisturbed, and shows no improvement in water release rates for the treated fabrics up to 20 minutes from dryness.

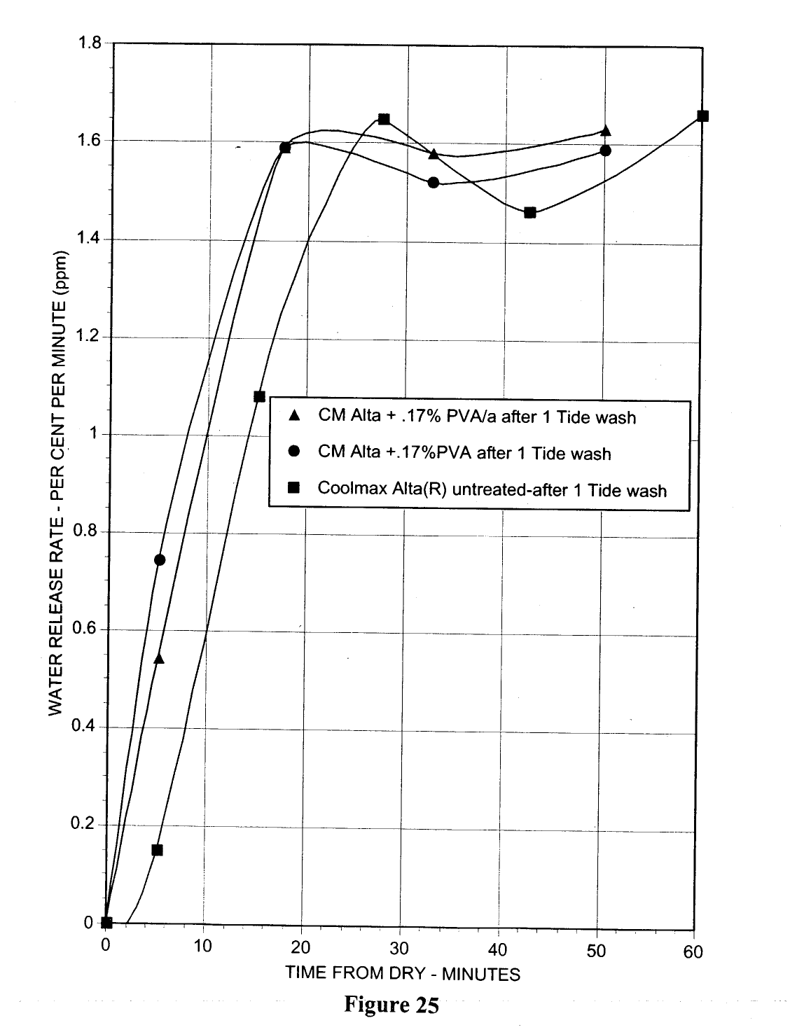

FIG. 25 shows the same fabrics as FIG. 24 after one wash with Tide home laundry detergent. This is more representative of the state the fabrics would be in after treatment plus washing or in use by a consumer. The single washing would not be expected to remove all of the textile finish on the fibers in all three fabrics, and certainly not all of the hydrophilic coating on the CoolMax® Alta fabric. As shown in FIG. 25, however, the single washing greatly reduces the water release rate for the untreated fabric at less than 15 minutes from dryness and greatly increases the water release rates of both treated fabrics over the entire drying range. As a result the water release rates of the PVA and PVA/a treated fabrics are 5× and 3.5× higher at 5 minutes from dryness than the untreated control.

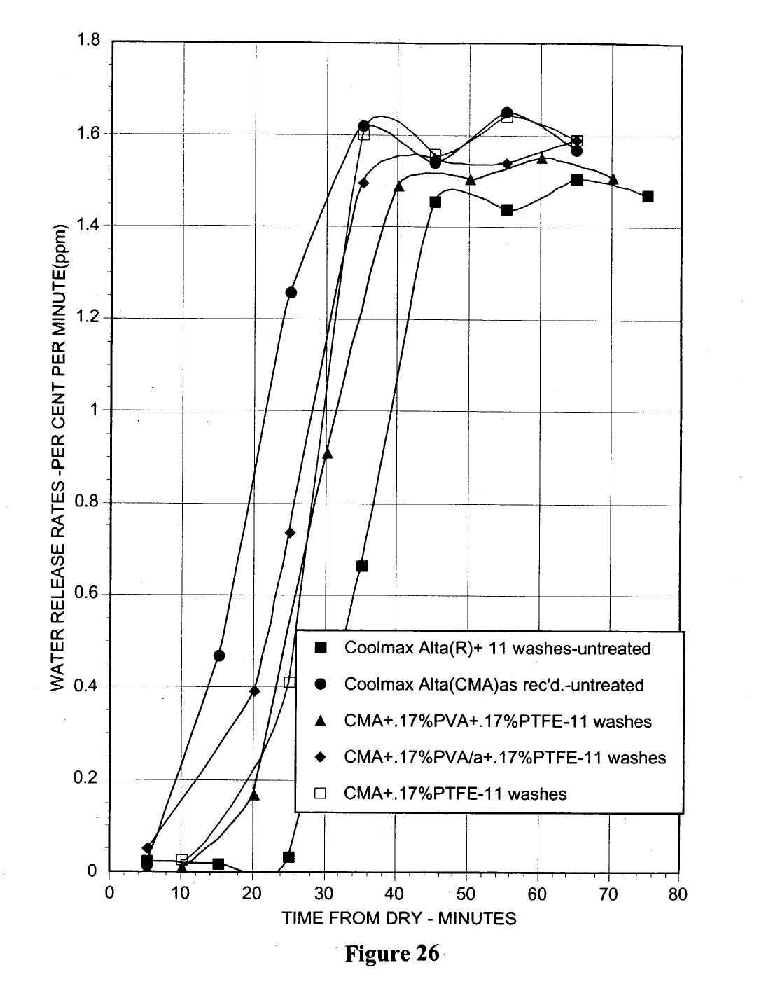

FIG. 26 shows the full water release rate plots for the 100% polyester CoolMax® Alta fabric at 70° F. and 40% R.H prior to washing, after one wash, and after the 11 washes in Example 22. A comparison of the untreated fabric prior to washing and after the 11 washes shows the large reduction in water release rate that occurs during the first 25 minutes from dryness for the repeatedly washed CoolMax® Alta fabric. The other curves show the effects of treating the untreated, PVA, and PVA/a treated fabrics with 0.17% PTFE.

The washed, but untreated CoolMax® Alta fabric does not reach water release rates sufficient to keep a garment dry in long term active exercise until 37 minutes from dryness, while the unwashed fabric does so in 19 minutes, with its hydrophilic finish and coating undisturbed. At least 14% more water will be built up in the washed CoolMax® Alta fabric, which means it will feel wet well before even half an hour of slow running. All of the washed, but treated CoolMax® Alta fabrics start increasing water release rate 15-20 minutes before the washed, untreated CoolMax® Alta and reach the minimum rate (0.8 percent of fabric weight per minute) for an equilibrium with sweat output 8 to 10 minutes sooner. This means that much less than the moisture amount that causes a wet feel will build up in the fabric before the water release rate matches the sweat output rate to stop moisture buildup.

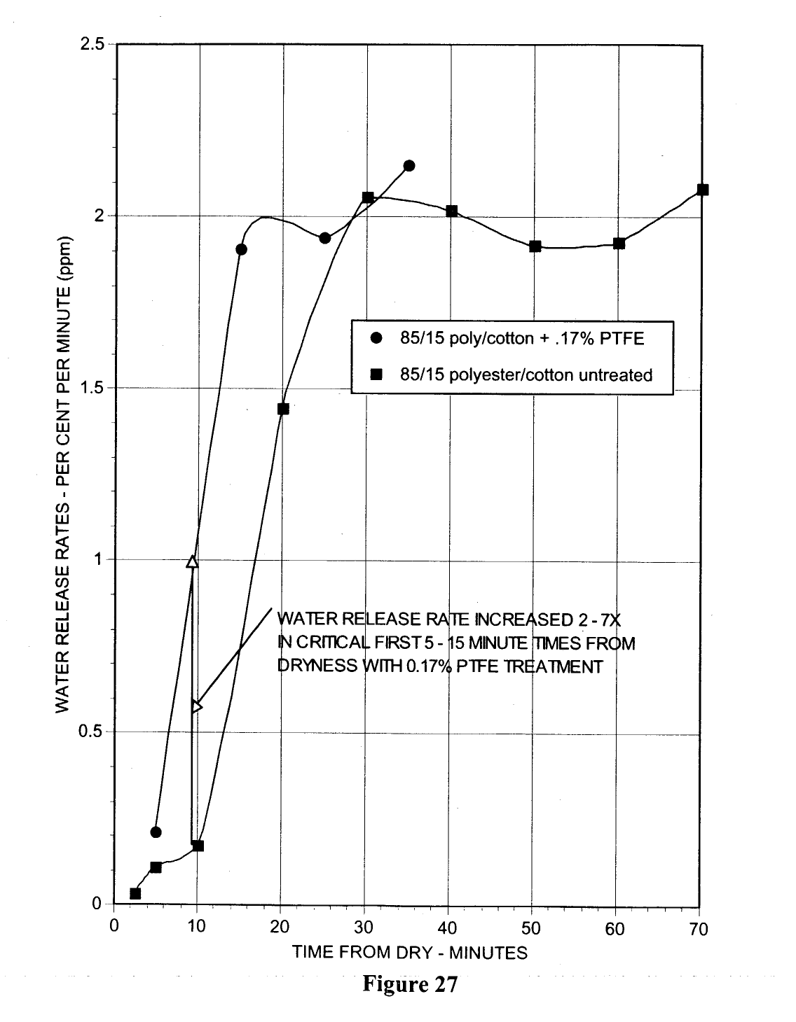

The fabrics used in Examples 21-24 varied in basis weight. Both Dri-release® fabrics had a higher basis weight than the Akwatek® and CoolMax® Alta fabrics. For comparison purposes, water release rates of 4.0 oz/yd² Dri-release® fabric having an intimate blend of 15% hydrophilic cotton fibers and 85% of co-polyester fibers were measured. FIG. 27 compares the water release rates of the unwashed 4.0 oz/yd² Dri-release® fabric left untreated and treated with 0.17% PTFE. As shown in FIG. 27, the 0.17% PTFE treatment gives the shortest time (8 mins.) to reach the 0.8 ppm water release rate. The 0.17% treatment increases the 5 to 15 minute water release rate up to 7× in that most critical period where the fabric reaches its full water release rate of 1.9 percent of fabric weight per minute, which is high enough to keep the most active athletes dry for longer times than such exercise can normally be maintained.

The Example 21-24 data shows that low levels of hydrophobic particle treatment will not only reduce spin-dry water content levels in fabrics after washing or swimming, but greatly increases the water release rates between dryness and the water content level that causes a fabric to feel wet, such that longer term, higher exercise levels can be performed without wetness, discomfort, or hypothermia and chills as would occur with untreated fabrics and garments.

### Example 26

### Treated Yarns and Fabrics

This example was done to see if low levels of PTFE could be applied directly to yarn using a PTFE dispersion in a production operation. Five-pound bobbins of Cavallier of Canada's ring-spun, non-waxed 20/2's (20 Cotton Count yarns, 2 plied) of Dri-release® 85/15 polyester/cotton staple intimate fiber-blend yarns were used for treatment at Spectrum Inc. in Hickory, N.C. A Daikin, Inc D-2, 60% PTFE dispersion in water was used undiluted, or diluted 1:1 with water to give a 30% dispersion. It was impractical to handle the dispersions in a more dilute form in the commercial yarn treating equipment at Spectrum.

The 20/2 yarns were pulled off over end and run thru a tensioning system, over a kiss roll (wet by rolling in a trough of the PTFE dispersion), picking up PTFE and then rewinding onto bobbins. It was found that air-drying the excess water off the yarns at 200-400 meters per minute between the kiss roll and the winder was sufficient. These treated yarns were then used to make fabrics for lab testing. One purpose of this test is to determine whether continuous treatment of yarns would permit treated fabrics to be made that would give equal or better drying and friction performance than dipping or spraying fabrics. Treating the yarns rather than the finished fabric can reduce the overall cost of manufacture.

The PTFE solids pick-up was determined for each test condition by skein-winding, drying and weighing 90 meters of treated yarn from each test. The weight per 90 meters untreated was compared to the treated weight to determine treatment level. Surprisingly low levels (0.2-0.28%) of PTFE were picked up in the first conditions tried. Lower operating speeds and the lower 30% PTFE concentration were necessary to make the higher target range (1-8%) of PTFE levels. The operating parameters used to obtain the various treatment levels are shown in Table 9.

TABLE 9
Operating parameters for PTFE coated yarns

| | Dispersion | | Yarn | |
|---|---|---|---|---|
| % PTFE | % PTFE | Winder RPM | Speed (m/min) | Kiss Roll RPM |
| 0.28 | 30 | 2240 | 493 | 6 |
| 0.21 | 30 | 2240 | 493 | 15 |
| 0.20 | 30 | 2240 | 493 | 20 |
| 1.01 | 30 | 1640 | 361 | 20 |
| 3.84 | 30 | 1640 | 361 | 10 |
| 4.36 | 30 | 880 | 194 | 10 |
| 2.25 | 60 | 880 | 194 | 10 |
| 6.37 | 60 | 880 | 194 | 20 |

As shown in Table 9, PTFE treatments levels of 0.20, 0.21, 0.28, 1.01, 2.25, 3.84, 4.36, and 6.37% were obtained.

The yarn samples were then tested to determine their blotted wetness and water release rates. Blotted wetness simulates the effect the spin-drying a garment and establishes its water content starting point for air-drying or machine drying. The blotted wetness, is comparable to the spin-dry water content. The blotted wetness value is determined by placing saturated yarns between two absorbent layers, applying a uniform pressure to the absorbent layers, and calculating the water content of the yarn upon removal.

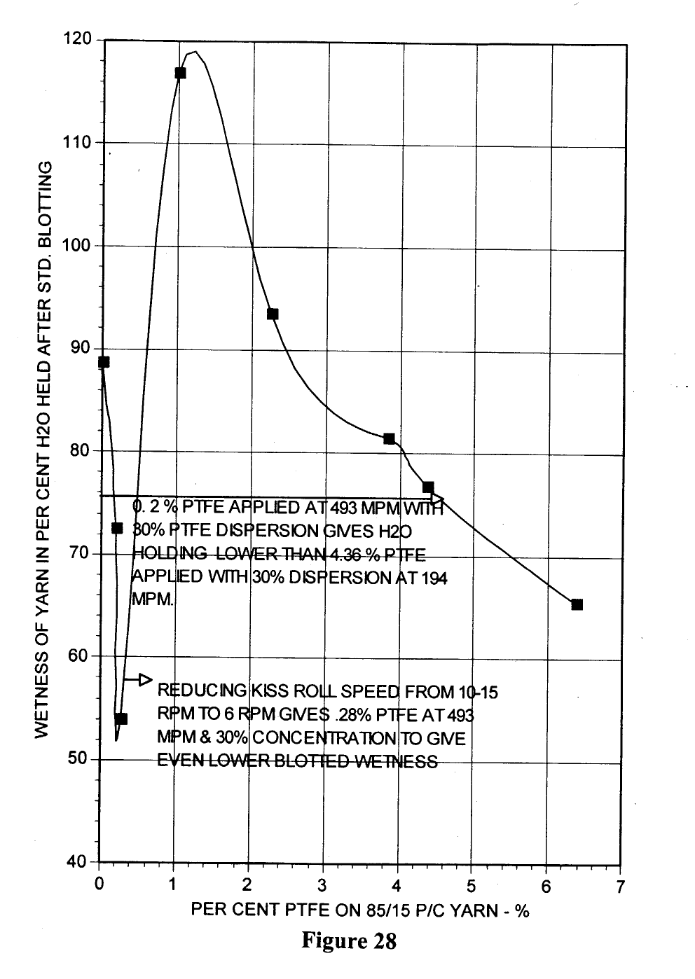

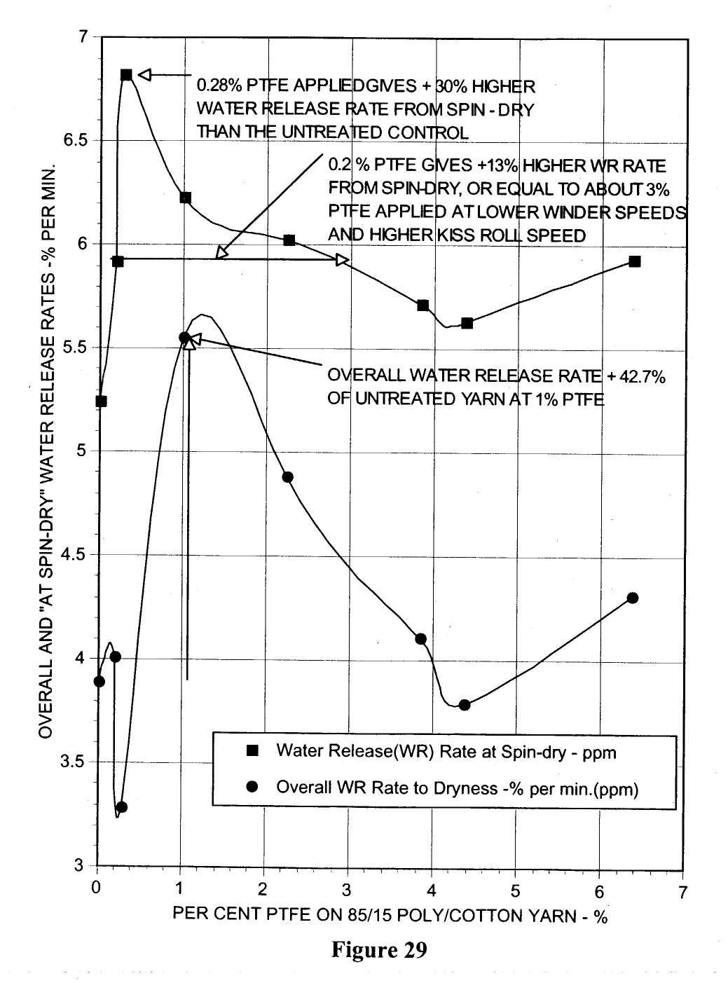

FIG. 28 compares the blotting wetness of the yarns treated with various levels of PTFE. FIG. 29 compares the water release rate near dryness and the overall water release rate of the yarns treated with various levels of PTFE. The rates are about 10× higher than comparable fabrics due to the higher specific surface area of an individual yarns. Table 10 provides the drying time for each of the yarns. The water release rates near dryness have a greater correlation with drying times than the overall rates.

TABLE 10
Yarn drying time.

| | Drying Time |
|---|---|
| % PTFE | (Min.) |
| 0 | 22.5 |
| 0.20 | 18 |
| 0.28 | 16 |
| 1.01 | 21.5 |
| 2.25 | 18.5 |
| 3.84 | 19.5 |
| 4.36 | 20 |
| 6.37 | 15 |

As shown in FIGS. 28 and 29, the low (0.2-0.28%) treatment level yarns obtained were found to give very surprisingly high water release rates. The undiluted and 1:1 diluted dispersions gave very low, uniform treatment levels at the high winding speeds that resulted in the best yarn and fabric drying, water release and friction performances (see Example 26, below) per add-on percent of PTFE.

At the highest machine speed (2240 rpm or 493 mpm) and lowest concentration (30% PTFE) the kiss roll process applied only 0.2 to 0.28% PTFE to the Dri-release® 85/15 co-polyester/cotton ring-spun staple yarn. The yarn was 20's cotton count two-plied to make an overall 10's cotton count size yarn for socks.

The lowest kiss roll speed of 6 rpm applied the most PTFE (0.28%) at the highest winder speed (2240 rpm). This also reduced the blotted wetness 39% from 88.6% water content for the untreated control yarn to 54% water content at 0.28% PTFE, as shown in FIG. 28. Higher kiss roll speeds also reduced the blotted wetness water content by lesser amounts of 25±3% at 15-20 rpm speeds.

In addition to blotted wetness water content, water release rates of the treated yarns are also important in determining their drying time. As shown in FIG. 29, the yarn with 0.20 PTFE increased the water release rate near the spin-dry water content 13%. At 0.28% PTFE, the water release rate near the spin-dry water content increased most (30%), but the overall water release rate was least at 0.28% PTFE. The overall water release rate peaked with 1% PTFE at a rate 42.7% greater than the untreated control. The water release rate near the spin-dry water content and the overall water release rates decreased up to 4.36% PTFE before beginning to increase again. The water release rates of the yarns are about 4-9× higher than those of fabrics due to the greater surface exposure per unit volume.

The data suggests that an optimum condition of 6 rpm at maximum 2240 rpm winder speed gives an improvement in drying time of 29% and a blotted wetness that is lower than 6.37% PTFE. The 6.37% was applied at 2.5× lower winder speed with the same 30% PTFE mix.

Projection of the FIG. 28 curve indicates that 10% PTFE would be needed to match the blotted wetness of 0.28% PTFE applied at the highest speed. Such high yarn speeds (493 meters per minute) are necessary for economic yarn spinning. Being able to couple dispersion treatment in-line with spinning greatly improves the economics of such an added treatment step.

The 0.2% PTFE would add only about 1.6 cents per pound to the materials cost of Dri-release® yarn. The high speed with quick drying should make it possible to add this step in-line with yarn spinning at very low incremental process cost.

The yarns made with 1% to 6.37% PTFE were all made at winder speeds of 1640 and 880 rpm, with 30 and 60% PTFE dispersions. These lower speeds may require a separate application step from yarn spinning which means extra handling and process costs. The materials cost of yarns increases about $0.51 per pound with 6.37% PTFE added. The processing costs associated with slower operating speeds could add about $0.50 per pound for a $1 per pound total yarn cost increase.

This compares favorably to the $30-40 per pound PTFE fibers like Teflon®, whose high price is diluted in socks using Teflon® strictly for friction reduction by using only 15-25% of the Teflon® fibers in the total content. This adds about $4.50 to $7.50 in materials cost per pound of socks and about $0.45 to $1.50 higher materials cost per pair of socks. Friction reduction is of much less value in non-sock applications, but the high water release rates discovered here are of value in all types of garments worn in hot, humid climates or used in active exercise. The economic data is provided to show potential economic advantages of the present invention in addition to the performance attributes already presented. The economic advantages may change over time and are not critical to the present invention.

As shown in FIG. 28, the blotted wetness seems to jump up to a higher regime at 1% PTFE and then drops down in a regular series to 26% lower blotted wetness than control at 6.37% PTFE. The latter level was achieved by using 60% PTFE dispersion at 880 rpm winder speed and 20 rpm kiss roll speed. As shown in Table 10, the time to final dryness goes from 4% lower than control at 1% PTFE to 33% lower than control at 6.37% PTFE. The final drying rate goes down with increasing PTFE amounts by 0.2% per % PTFE added above 1%. This is more than offset by the blotted wetness or starting water content going down from 5% to 16% per % PTFE added. The gradually decreasing rate of improved performance as the amount of PTFE added increases indicates that a point of uneconomic return will be reached at higher PTFE levels.

### Example 27

### Friction Properties of Treated Yarns

The same yarns tested in Example 26 were sent to Philadelphia University Textile Dept. for friction testing of Rothschild yarn-on-yarn coefficient of friction. The residues of yarn on each test bobbin were then knit on a single end circular knitting machine into single-knit fabrics. The fabrics were then tested by the Kawabata sled test for fabric coefficient of friction (COF).

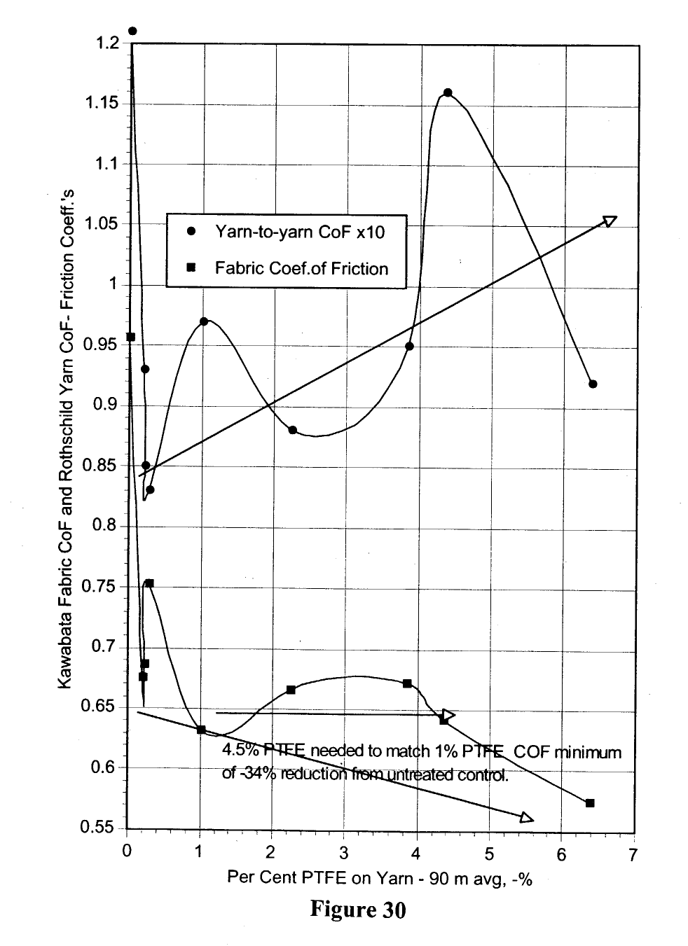

FIG. 30 compares the frictional properties of the yarns treated with various levels of PTFE. As shown in FIG. 30, the yarn and fabric COF's seem to have an inverse relationship from 0.2% to 4.36%. They both seem to decrease rapidly from 0% to 0.2-0.28% PTFE, dropping 110% for the yarn and 148% for the fabric per % PTFE added. From 4.36% to 6.37% the yarn-to-yarn COF only drops 10.1% and the fabric COF drops 7.8% per % PTFE added. The yarn-to-yarn COF minimum is 31.4% less than control at 0.28% PTFE, which is not matched by any higher % PTFE in this test up to 6.37%. The overall trend of yarn-to-yarn COF is up with increasing PTFE above 0.28%.

The fabric COF minimum of 29.5% in the low range is at 0.21% PTFE and in a mid-range is 34% below control at 1% PTFE after a peak at 0.28% PTFE. The overall fabric COF trend is down with increasing PTFE %, but it takes 3-4.5% PTFE in the higher PTFE range to give the low COF's achieved by the 0.21% and 1% PTFE samples.

### Example 28

### Bulk Properties of Fabrics Made From Treated Yarns

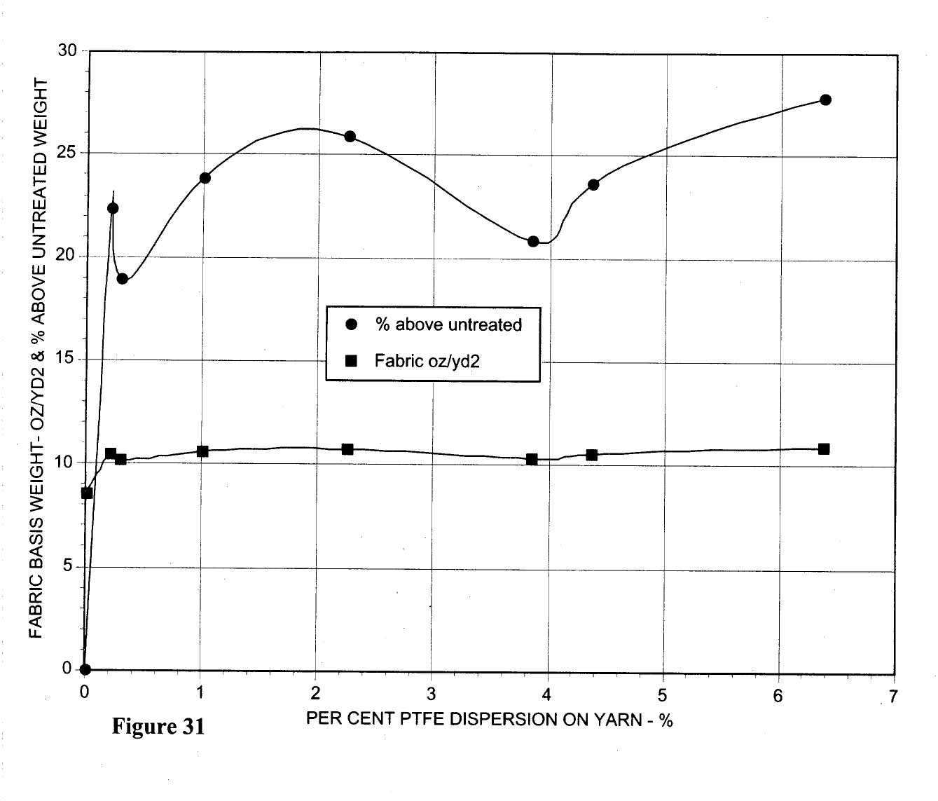

Fabric aesthetics are also strongly affected by even the lowest PTFE treatment levels. FIG. 31 shows that the basis weight or bulk of the fabrics knit from the various PTFE treated yarns of Examples 26 and 27. As shown in FIG. 31, the increase in bulk is significant compared to the level of PTFE added.

All of the treated fabrics fall in the range 10.14 to 10.9 oz/yd² versus the untreated fabric 8.53 oz/yd² weight. The treated fabrics all felt bulkier, smoother and slicker than the untreated control. The untreated control felt very limp and cheap compared to even the 0.2% PTFE yarn fabric. This is of commercial value since bulkier fabrics are valued and sold at higher prices.

### Example 29

### Treatments on Various Cotton Fabric Types

Disks were cut as described in the above examples from multiple washed and worn Claiborne golf shirts made in the Northern Marianas Islands. The shirts were made out of 100% unmercerized cotton or 100% mercerized cotton and had a similar construction. Mercerized cotton fabrics have a sheen and more quality hand than unmercerized cotton fabrics, which has led to their predominant use in premium athletic shirts for such sports as golf, despite their higher cost. Mercerization applies tension with heat and chemicals to reconstitute the folded and collapsed original tubes of each cotton fiber back to an unfolded and uncollapsed state.

The basis weights were 6.0 and 5.0 oz/yd² for the unmercerized and mercerized shirts, respectively, after two years of wearings and home washings in Tide in a Sears Kenmore washer-drier set. The heavier basis weight of the unmercerized shirt was observed to develop progressively with multiple washings, while the mercerized shirt was relatively unaffected by repeated washings.

Starting weights of the 69 mm disks were carefully determined on a 5 place Mettler AE 163 scale at 69° F. and 23% R.H. Control disks were sprayed with water to simulate the treatments used to apply 0.2% dispersions in water of Daikin D-2 PTFE, PVA, and PVA/a dispersions described in earlier examples.

The above 0.2% dispersions were sprayed on the various disks to give equal weights added to the dry starting weights. The disks were then allowed to dry in air at the above conditions and re-weighed to determine the percent solids pick up. Slight variations from the goal 0.2% additions were recorded, but the pick up of the mercerized samples was very uniform at 0.16% for all three treatments. The unmercerized cotton pick-ups varied somewhat at 0.26% for the PTFE, 0.2% for the PVA, and 0.33% for the PVA/a.

The fabric disks were then wet by pressing a wet Kimberly-Clark 05930 WypAll X80 nonwoven cloth towel uniformly to all four samples simultaneously on the inside, treated surface to simulate the pick up of sweat from the skin. The towel was wet to excess and then squeezed uniformly to a fully wet condition at 250% water content. The wetter feeling orange side of the towel was pressed against the test samples for 5 seconds under uniform pressure.

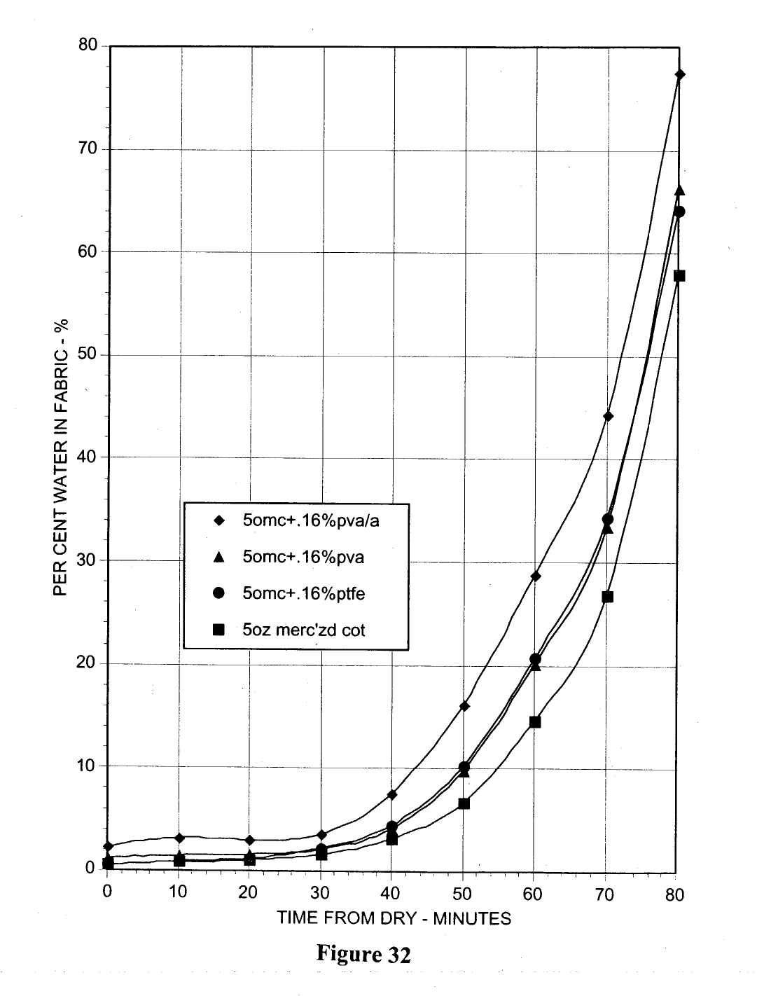

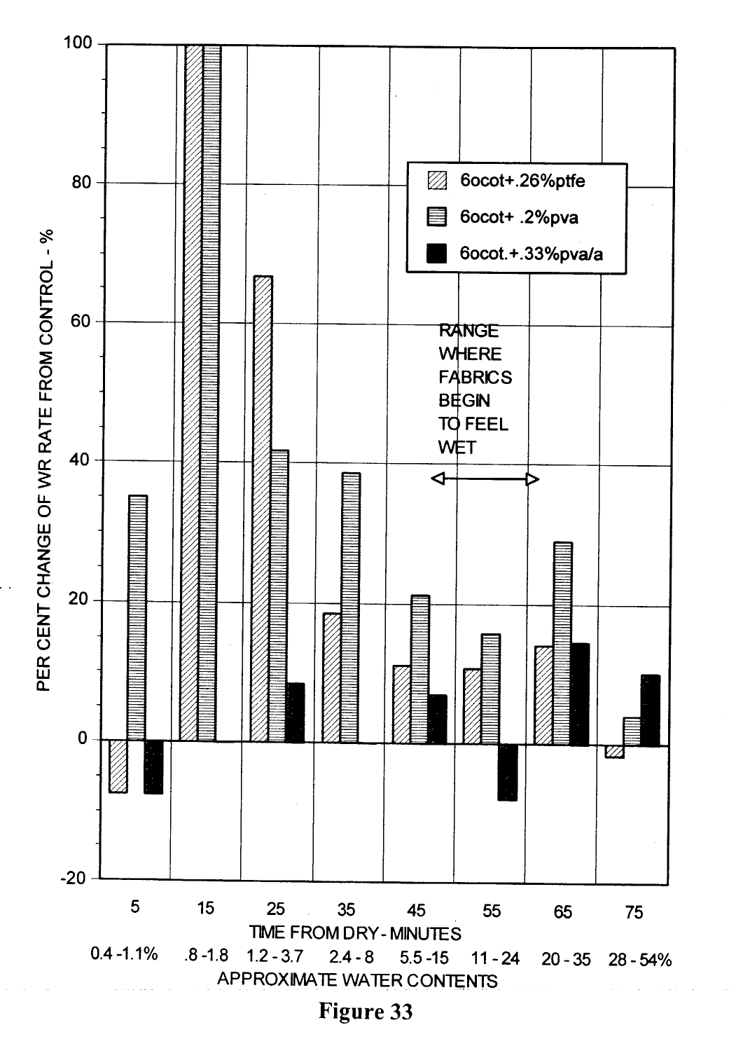

FIG. 32 shows the drying curves for the mercerized cotton samples. As shown in FIG. 32, the water pick up was higher for the surface treated samples than for the untreated control, as shown at the 80 minute wet side of FIG. 32. The time for release of a fixed percent moisture can be seen to be shorter for the treated disks than for the untreated control, e.g. for 20% water, cotton took 66 minutes to release the water, with 0.16% PTFE and PVA 60 minutes, and with 0.16% PVA/a 54 minutes. This corresponds with the water release rate water release rate data in FIG. 33. FIG. 33 shows the water release rates at various water contents relative to the water release rates of the control. As shown in FIG. 33, the PVA/a treated fabric has a 163% higher water release rate relative to the untreated control from about 2 to 7% water content. Such differences are reproducible and characteristic of each combination. As shown in FIGS. 32 and 33, the PTFE and PVA treated disks at 0.16% addition on the mercerized cotton were similar in drying curves, except below about 5% water, where the PVA had strongly negative water release rates relative to the control and the PTFE treated disks were strongly positive versus control.

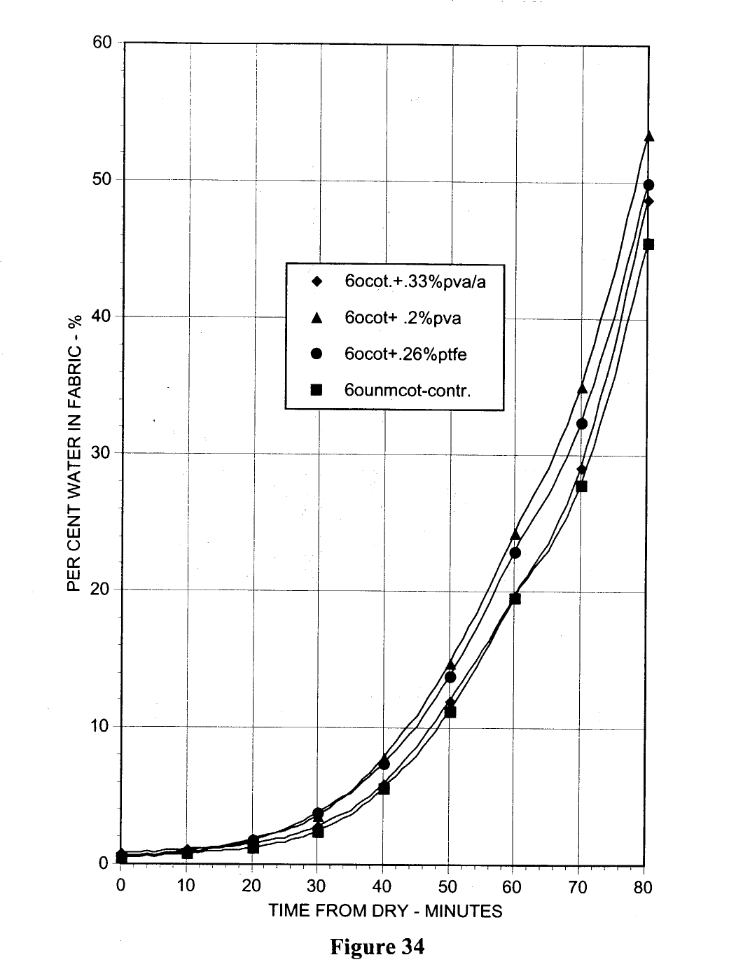

FIG. 34 shows the drying curves for the unmercerized cotton samples. As shown in FIG. 34, the unmercerized cotton disks gave similar results to the mercerized cotton, but to a slightly lesser degree, and with a different response to each dispersion. FIG. 34 shows the untreated control taking 60 minutes to release 20% moisture. The PVA/a treated disk took the same time and released only 23% more moisture than control over an 80 minute period. A comparison of the performance differences between the mercerized and unmercerized cotton disks with each type of treatment shows how the selection of treatment types and application amounts may provide varying results for different fabric types. For example, the PVA/a applied at a higher add-on on the unmercerized cotton provided lower drying rates than lower levels applied on mercerized cotton.

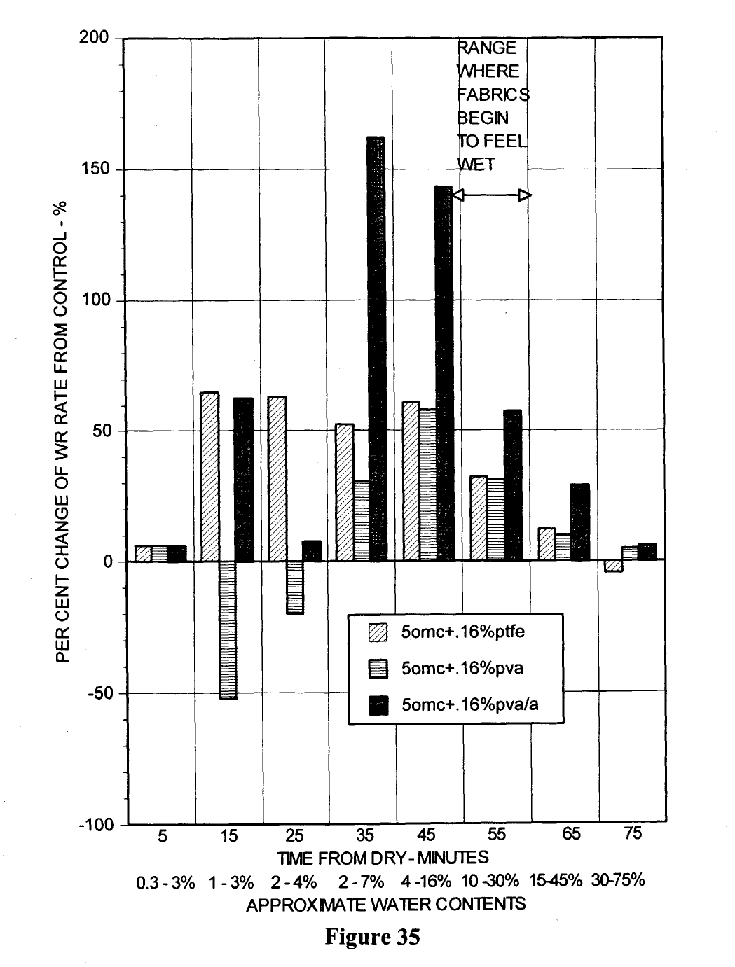

FIG. 35 shows the water release rates at various water contents relative to the water release rates of the unmercerized control. As shown in FIG. 35, the PVA and PTFE disks both had strongly positive water release rates over most of the range tested. In fact the PVA treated disks were strongly positive from 0.4% to at least 8% on the unmercerized cotton, while the PVA/a treated disks gave very little positive or negative difference over the entire range tested on unmercerized cotton. The PVA treatment gave positive water release rates relative to control over the entire range for the unmercerized cotton.

The significance of this is that PVA is a very inexpensive polymer which can give unmercerized cotton fabrics higher water release rates and improved comfort levels without adding much cost to the billions of pounds of inexpensive, unmercerized cotton used to manufacture clothing. The PTFE is 10-20× more expensive than PVA.

### Example 30

### Water Release Rates of T-Shirt Fabric at Various PTFE Treatment Levels

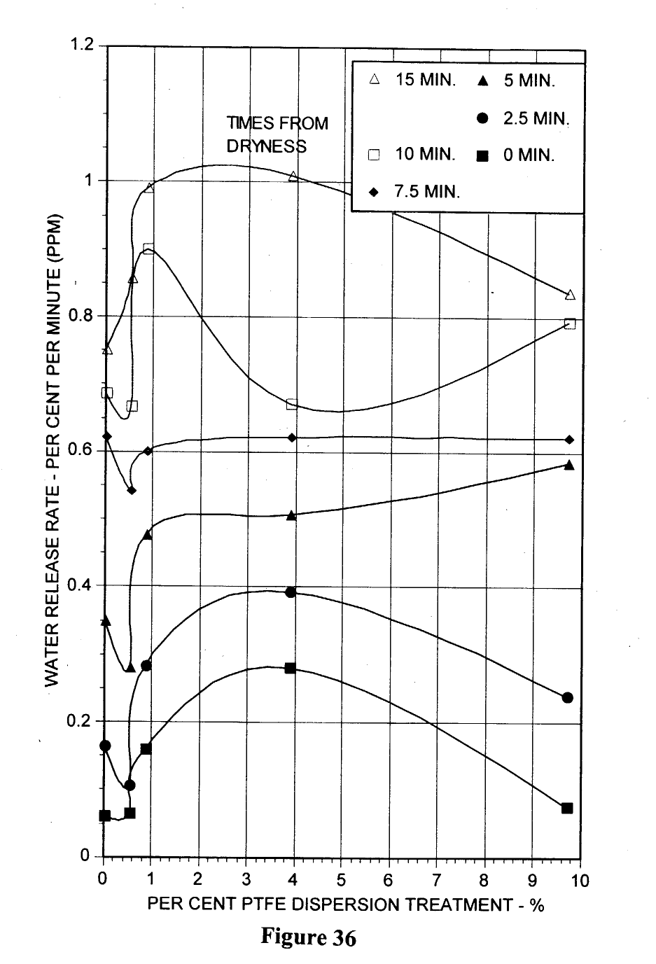

Water dispersions of 0.5%, 1%, 4% and 10% were prepared by dilution of Dupont Teflon 30B 60% solids dispersion in water. Disks of 5.5 oz./yd² basis weight 85/15 polyester/cotton jersey knits punched from t-shirts were then washed, dried and sprayed on the inside with each of the dilutions to an amount equal to the original dry weight of each disk. A control was sprayed with water only. The disks were allowed to dry overnight in a 70° F. and 25% relative humidity area, and reweighed when dry to determine the actual percent PTFE picked up in each case. The control disks returned to their original weight, while the treated disks weighed 0.54%, 0.86%, 3.9% and 9.7% more respectively, indicating the percent PTFE picked up in each case. The disks were then rewet to the range of 33 to 48% water by spraying on the inside surface and placed face up on a non-absorbent surface to dry with their face sides exposed to the above conditions. The disks were weighed sequentially and rapidly on a Mettler AE 163 four digit electronic scale in a timed series down to less than 0.5% water as percent dry fabric weight. The percent water contents were calculated at 1 to 5 minute intervals until all were dry to less than 0.5% moisture in a 65 minute period. Water release rates were calculated at the final rate near dryness, and at 2.5, 5, 7.5, 10 and 15 minutes from dryness. The results are show in FIG. 36. As shown in FIG. 36, the water release rate at dryness (i.e. 0 minutes) is increased over the control sample above 0.54% PTFE and up to 9.7%, where it approaches the water release rate of the untreated control. The 2.5 and 15 minute water release rate curves are similar. The results show significant improvements in water release rates near dryness when small amounts of PTFE are applied to the fabrics.

### Example 31

### Water Release Rates of Denim Treated with PTFE

Using the methodology for preparing samples and determining water release rates discussed above, water release rates were determined for denim fabrics. The face side of the denim is the side that is worn away from the skin (the outside of a denim garment). The back side is the side that is nearest the skin (the inside of a denim garment).

Two denim fabrics were tested. The first fabric was a Levi denim cut from their commercial Type 505® 14.4 oz/yd² men's denim purchased at retail. The second fabric was a 12.6 oz/yd² 75/25 polyester/cotton denim fabric made by UCO of Belgium by using Dri-release® 85/15 polyester/cotton fill yarn on a 65/35 polyester/cotton warp, in a 50/50 warp/fill ratio.

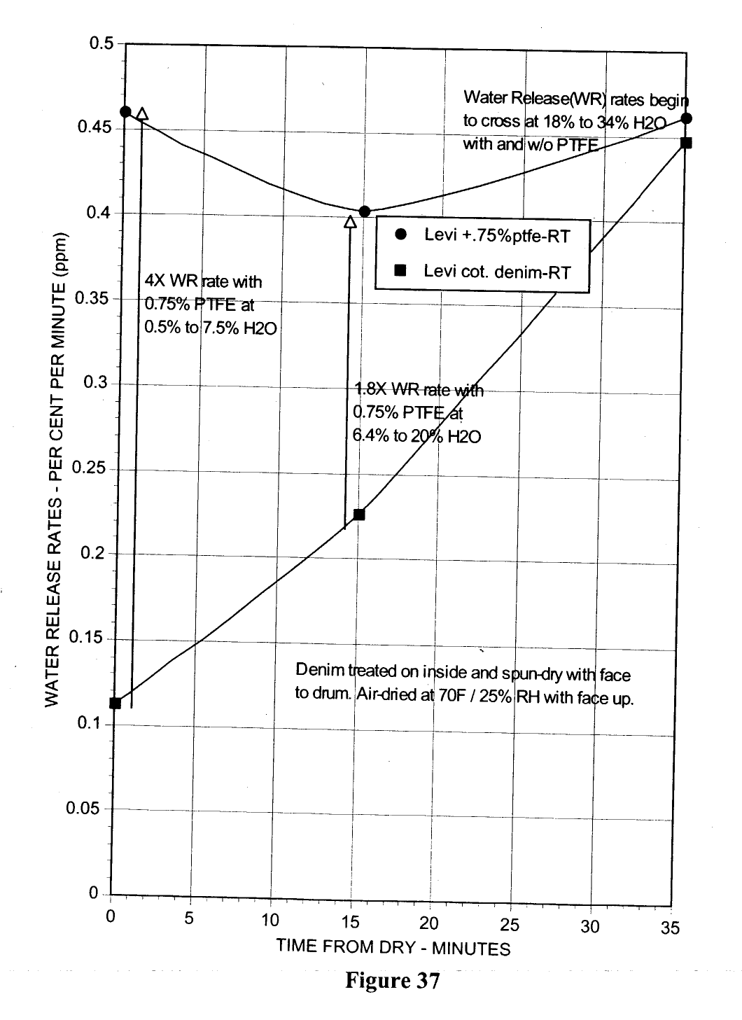

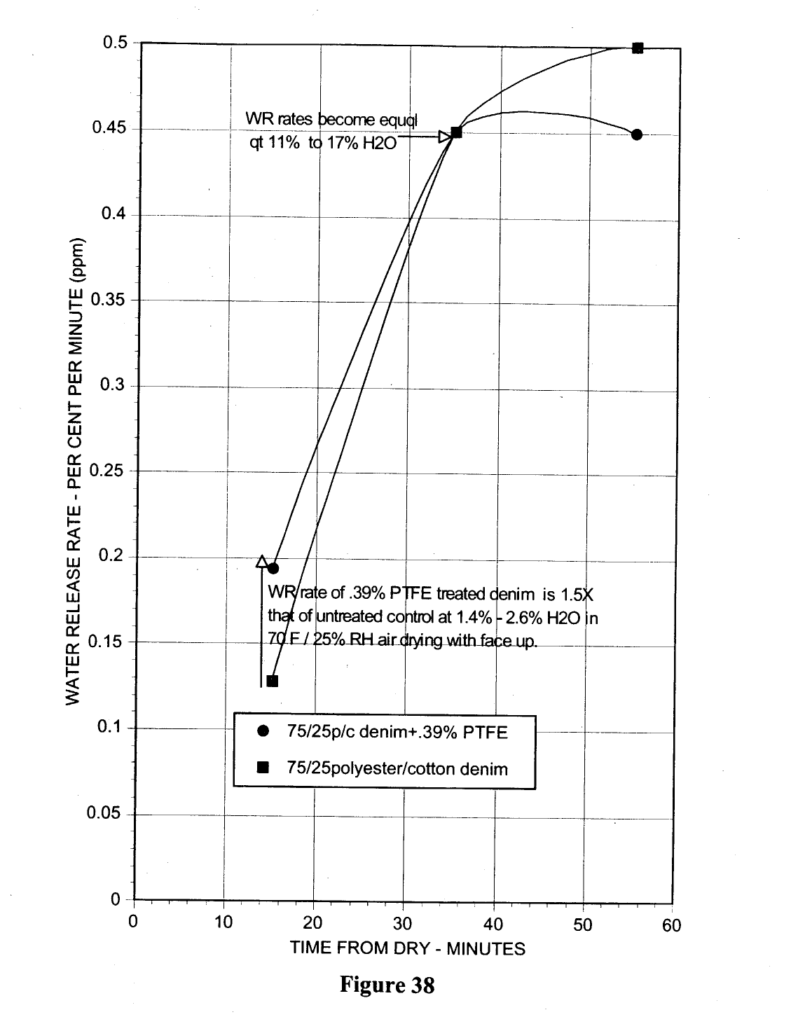

The fabrics were treated with a 0.2% PTFE dispersion and add-ons were determined. The fabrics were then soaked, spun-dry, and left to dry in a controlled environment on a non-absorbent surface with their face side up. The results are shown in FIGS. 37-41. FIG. 37 compares the water release rates of treated and untreated Levi Type 505® 14.4 oz/yd² denim. As shown in FIG. 37, applying 0.75% PTFE to the back of the denim increased the water release rate near dryness of the denim fabric. FIG. 38 is a chart comparing the water release rates of a treated and untreated 12.6 oz/yd² 75/25 polyester/cotton denim fabric. As shown in FIG. 38, applying 0.39% PTFE to the polyester/cotton denim fabric increased the water release rate around 1.4 to 2.6% water content.

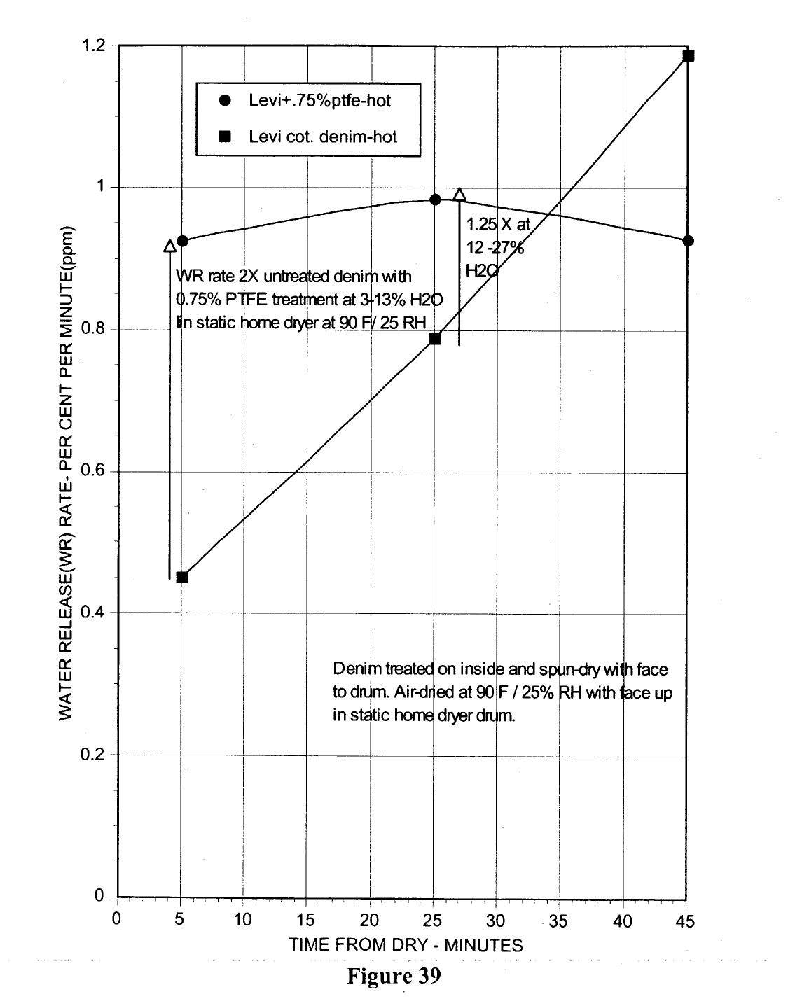

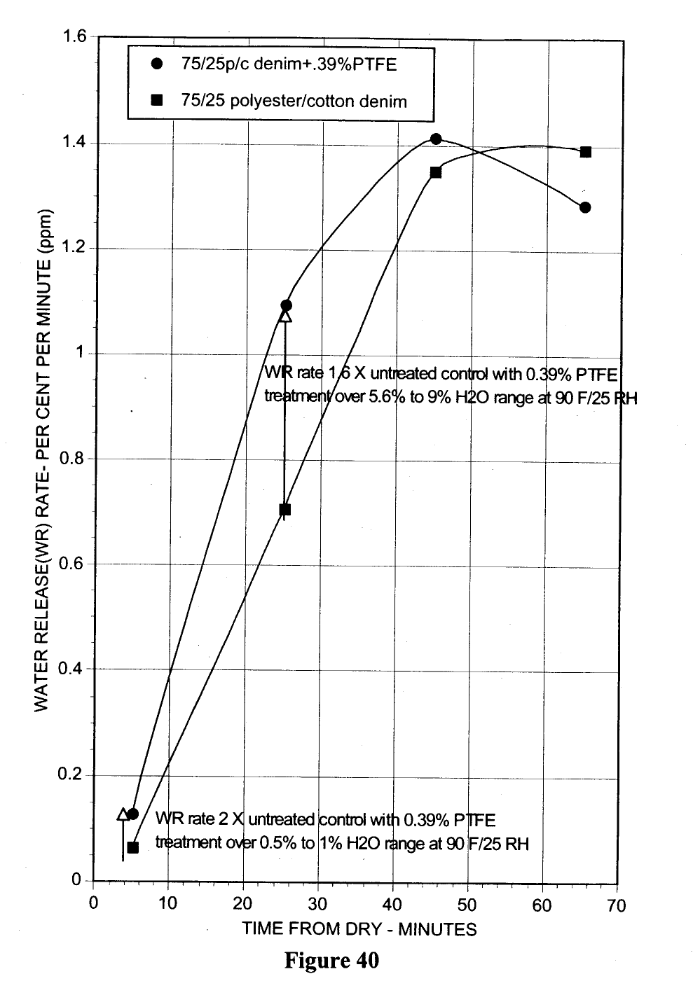

FIGS. 39 and 40 compare the same fabrics as FIGS. 37 and 38, except the temperature during drying was elevated from 70 to 90° F. As shown in FIGS. 39 and 40, the PTFE treated denim maintains water release rates that are higher than untreated denims at elevated temperatures.

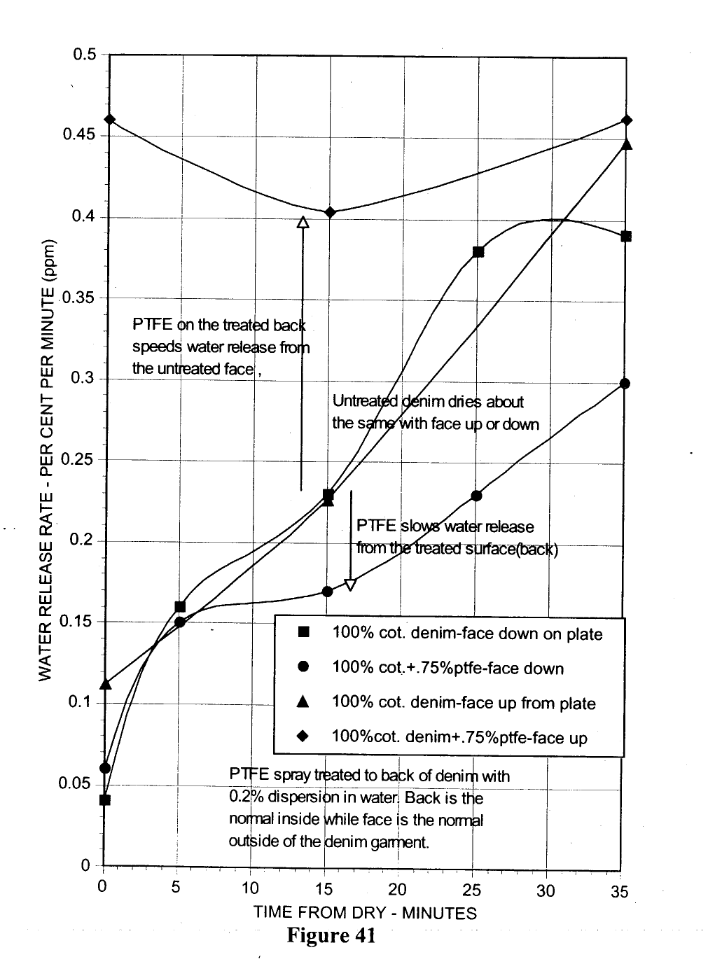

FIG. 41 is a chart comparing the water release rates of Levi Type 505® 14.4 oz/yd² denim without treatment, with treatment applied to the face, and with treatment applied to the back. As shown in FIG. 41, the untreated denim had very little directional effect, but treating the back side of the denim had a strong effect on increasing the water release rate of the denim.

### Example 32

### Application Methods

As an alternative to providing consumers with treated fabrics, textiles, and garments, the consumer can treat their articles themselves using a spray bottle. Preferably, the spray bottle operates by hand and has a finger operated trigger or finger operated pump. In one embodiment, the spray bottle is supplied with a small amount of concentrated dispersion and the consumer dilutes the dispersion with water prior to use. Supplying the dispersion in a concentrated form with an unfilled spray bottle reduces shipping and handling costs.

In a preferred embodiment, the concentrated dispersion is shipped in a small package at a concentration level of 60% solids by weight, and the spray bottle is designed to hold additional water to dilute the concentrated dispersion to about 0.1 to 1% solids. After purchase, the consumer empties the contents of the small package into the spray bottle's container, fills the container with water as directed, and mixes the solution. The consumer then uses the spray bottle to treat fabrics, garments, and textiles as desired. The spray bottle can be refilled and reused. The concentrated dispersions for home use can be sold with or without the spray bottle.

Aerosol spray cans provide an alternative to a consumer using a water dispersion to treat fabrics and garments in their home. The aerosol spray cans provide a convenient method for consumers to treat fabrics and garments in their home.

Using the methodology for determining water release rates discussed above, 85/15 polyester/cotton fabrics were treated with PTFE dispersions applied using spray bottles with various PTFE concentrations below 1.0 weight %. Samples of the same fabric were also treated with either PTFE particles or PVA/a particles applied with an aerosol propellant. Samples with varying amounts of treatment below 1.0 weight % were prepared.

After drying and determining add-on rates, the fabrics were tested. The fabrics treated with the aerosol spray had lower water contents after spin-dry and reducing drying times compared to the fabrics treated with the PTFE water dispersion. The use of an aerosol propellant also reduced the fabric drying time during the treatment process.

It is to be understood that even in the numerous characteristics and advantages of the present invention set forth in the foregoing description and examples, together with details of the function of the invention, the disclosure is illustrative only. Changes can be made to details, especially in matters of the quantity and type of dispersion used, the method of application, and the type, weight, and construction of textile material treated within the principles of the invention and to the full extent indicated by the broad general meaning of the terms in which the appended claims are expressed.

What is claimed:

1. A textile material comprising a surface and a discontinuous treatment located on said surface, said discontinuous treatment comprising discrete, individual particles that are more hydrophobic than said surface,
wherein said discontinuous treatment is in the range of about 0.1% to about 8% by weight of said textile material and increases the water release rate near dryness of said textile material.

2. The textile material of claim 1, wherein said textile material is a fiber.

3. The textile material of claim 1, wherein said textile material is a yarn.

4. The textile material of claim 1, wherein said textile material is a fabric.

5. The textile material of claim 1, wherein said textile material comprises one or more of polyester, cotton, or wool.

6. The textile material of claim 4, wherein said textile material is a linen.

7. The textile material of claim 4, wherein said textile material is an article of clothing.

8. The textile material of claim 7, wherein said article of clothing comprises about 10 to 15 weight % cotton and about 85 to 90 weight % polyester.

9. The textile material of claim 1, wherein said water release rate near dryness is increased by at least 10%.

10. The textile material of claim 1, wherein said water release rate near dryness is increased by at least 20%.

11. The textile material of claim 1, wherein said discontinuous treatment is in the range of about 0.1% to about 4% by weight of said textile material.

12. The textile material of claim 11, wherein said treatment is in the range of about 0.1% to about 2% by weight of said textile material.

13. The textile material of claim 1, wherein said discontinuous treatment comprises a fluoropolymer.

14. The textile material of claim 13, wherein said fluoropolymer is polytetrafluoroethylene.

15. The textile material of claim 1, wherein said discontinuous treatment comprises one or more of polyvinyl acetate and a polyvinyl acetate/acrylic copolymer.

16. The textile material of claim 1, wherein said discontinuous treatment comprises a combination of at least two of polytetrafluoroethylene, polyvinyl acetate, and a polyvinyl acetate/acrylic copolymer.

17. The textile material of claim 3, wherein said surface of said fabric is a flat knit.

18. The textile material of claim 3, wherein said surface of said fabric is a loop knit.

19. The textile material of claim 1, wherein said discontinuous treatment is applied uniformly over substantially all of said surface of said textile material.

20. The textile material of claim 1, wherein said surface further comprises a treated and an untreated area, and said discontinuous treatment is applied in said treated area, wherein said treated area has a higher water release rate than said untreated areas.

21. The textile material of claim 20, wherein said textile material is an article of clothing having a body side surface and an outer surface, said treated area proximate said body side surface and said untreated area proximate said outer surface.

22. The textile material of claim 1, wherein said textile material is an article of clothing having a body side layer and an outer layer, said body side layer having a body side absorbency, said outer layer having an outer layer absorbency,
wherein said surface and said discontinuous treatment are located on said body side layer, and said body side absorbency is less than said outer layer absorbency.

23. The textile material of claim 22, wherein said outer layer is cotton.

24. The textile material of claim 23, wherein said body side layer comprises polyester and cotton.

25. A fabric comprising a hydrophilic surface and a discontinuous treatment that is more hydrophobic than said hydrophilic surface, said discontinuous treatment comprising discrete, individual particles located on said hydrophilic surface,
wherein said discontinuous treatment is in the range of about 0.1% to about 8% by weight of said fabric and increases the water release rate near dryness of said fabric.

26. The fabric of claim 25, wherein said discontinuous treatment is in the range of about 0.1% to about 4% by weight of said fabric.

27. The fabric of claim 25, wherein said discontinuous treatment is in the range of about 0.1% to about 2% by weight of said fabric.

28. The fabric of claim 25, wherein said water release rate near dryness is increased by at least 10%.

29. The fabric of claim 25, wherein said discontinuous treatment comprises one or more of polytetrafluoroethylene, polyvinyl acetate, and a polyvinyl acetate/acrylic copolymer.

30. The fabric of claim 25, wherein said fabric comprises one or more of polyester, cotton, or wool.

31. A textile material comprising a surface and a discontinuous treatment located on said surface, said discontinuous treatment comprising discrete, individual particles of one or more of polyvinyl acetate and a polyvinyl acetate/acrylic copolymer, wherein said discontinuous treatment is present in an amount sufficient to increase the water release rate near dryness of said textile material.

32. The textile material of claim 31, wherein said discontinuous treatment is in the range of about 0.1% to about 8% by weight of said textile material.

33. The textile material of claim 31, wherein said discontinuous treatment is in the range of about 0.1% to about 4% by weight of said textile material.

34. The textile material of claim 31, wherein said discontinuous treatment is in the range of about 0.1% to about 2% by weight of said textile material.

35. The textile material of claim 31, wherein said textile material is a fabric.

36. The textile material of claim 31, wherein said water release rate near dryness is increased by at least 10%.

37. A method for treating a textile material, comprising the step of applying discrete, individual particles of a treatment on said textile surface,
wherein said treatment is more hydrophobic than said textile material, said treatment is in the range of about 0.1% to about 8% by weight of said textile material, and said treatment increases the initial water release rate of said textile material.

38. The method of claim 37, wherein said treatment comprises one or more of polytetrafluoroethylene, polyvinyl acetate, and a polyvinyl acetate/acrylic copolymer.

39. The method of claim 37, wherein said treatment increases said initial water release rate by at least 10%.

40. The method of claim 37, wherein said discontinuous treatment is in the range of about 0.1% by weight to about 4% by weight of said textile material.

41. The method of claim 37, wherein said discontinuous treatment is in the range of about 0.1% by weight to about 2% by weight of said textile material.

42. The method of claim 37, wherein said textile material is a yarn.

43. The method of claim 42, further comprising the step of knitting or weaving said yarn into a fabric.

44. The method of claim 37, further comprising the step of creating an article of clothing from said textile.

45. The method of claim 37, wherein said treatment is applied by spraying or saturating said textile with a dispersion comprising said treatment.

46. The method of claim 37, wherein said textile material is a fabric.

47. The method of claim 46, wherein said treatment is applied by spraying or saturating said fabric with a dispersion comprising said treatment.

48. The method of claim 47, further comprising the step of creating an article of clothing from said fabric.

49. The method of claim 37, wherein said textile material is an article of clothing.

50. The method of claim 37, wherein said treatment is applied using an aerosol propellant.

51. The method of claim 37, wherein said treatment is applied using a hand operated spray bottle.
